(19) United States
(12) Patent Application Publication
(10) Pub. No.: US 2026/0365234 A1
(43) Pub. Date: Nov. 19, 2026

(54) METHODS AND APPARATUS TO CONFIGURE A RETURN-TO-CENTER ANGLE FOR A STEERING WHEEL

(71) Applicant: Ford Global Technologies, LLC, Dearborn, MI (US)

(72) Inventors: Ashrit Das, Canton, MI (US); Rohan Divekar, Canton, MI (US)

(21) Appl. No.: 19/209,520

(22) Filed: May 15, 2025

(51) Int. Cl. B62D 5/04; B62D 6/00

(52) U.S. Cl. CPC B62D 5/0466; B62D 6/008

(57) ABSTRACT

Methods and apparatus to adjust a steering angle of a vehicle in a self-driving mode are described herein. An example vehicle disclosed herein includes a steering controller including instructions and programmable circuitry to execute the instructions to a steering wheel, a steerable wheel, a steering motor to be activated to control a steering angle of the steering wheel while the vehicle is in an assisted driving mode, and programmable to: access a trajectory plan for the vehicle, the trajectory plan including a curvature; determine a return-to-center (R2C) angle for the steering wheel based on the trajectory plan and a vehicle speed; and cause the steering motor to bias the steering angle of the steering wheel towards the R2C angle in response to the steering wheel receiving a torque input from a driver.

### FIELD OF THE DISCLOSURE

This disclosure relates generally to vehicle control and, more particularly, to methods and apparatus to configure a return-to-center (R2C) angle for a steering wheel.

### BACKGROUND

In recent years, some vehicles have been outfitted with automated driving systems that can automatically drive or steer the vehicle in a self-driving mode. These systems include a path follower controller that analyzes the road ahead (e.g., using one or more cameras and or Map based systems) and determines how to steer the vehicle along a target path based on the analysis. The path follower controller determines a torque to be applied by a steering motor to the steering system to steer the vehicle. In some instances, while in the self-driving mode, the driver may still need to manually steer the vehicle.

### SUMMARY

An example vehicle disclosed herein includes a steering wheel, a steerable wheel, the steering wheel operatively coupled to the steerable wheel, and a steering motor to be activated to control a steering angle of the steering wheel while the vehicle is in a self-driving mode. The vehicle also includes a steering controller including instructions and programmable circuitry to execute the instructions to: access a path follower (PF) angle request, the PF angle request including a curvature; determine a return-to-center (R2C) angle based on the PF angle request and a vehicle speed; and cause the steering motor to bias the steering angle towards the R2C angle in response to the steering wheel receiving a torque input from a driver.

Disclosed herein is an example non-transitory machine readable storage medium that includes instructions to cause programmable circuitry to at least: identify a trajectory plan for a vehicle, determine a return-to-center (R2C) angle for a steering wheel based on the trajectory plan, the R2C angle being non-zero, and cause a steering motor to bias a steering angle of the steering wheel towards the R2C angle in response to the steering wheel receiving a torque input from a driver.

An example method disclosed herein includes identifying a trajectory plan for a vehicle, determining a return-to-center (R2C) angle based on the trajectory plan, and causing a steering motor to bias a steering angle towards the R2C angle in response to a steering wheel receiving a torque input from a driver.

### BRIEF DESCRIPTION OF THE DRAWINGS

FIG. 1 illustrates an example vehicle in which the example methods and apparatus disclosed herein can be implemented.

FIG. 2A is a schematic of an example steering system of the example vehicle of FIG. 1 including an example steering controller used to steer the vehicle in a self-driving mode.

FIG. 2B is a schematic of another example steering system of the example vehicle of FIG. 1 including an example steering controller used to steer the vehicle in a self-driving mode.

FIG. 3 is a block diagram of example return to center (R2C) angle determination circuitry of the example steering controller of FIGS. 2A-2B.

FIG. 4 is a block diagram of the example steering controller of FIGS. 2A-2B.

FIG. 5 is a block diagram of example virtual boost curve (VBC) circuitry of the example steering controller of FIGS. 2A-2B.

FIG. 6 is a block diagram of example angle blending circuitry of the example steering controller of FIGS. 2A-2B.

FIG. 7 illustrates an example final angle request generation operation performed by the example steering controller of FIGS. 2A-2B.

FIG. 8 is a flowchart representative of example machine readable instructions and/or example operations that may be executed, instantiated, and/or performed by example programmable circuitry to implement the R2C angle determination circuitry of FIG. 3.

FIG. 9 is a flowchart representative of example machine readable instructions and/or example operations that may be executed, instantiated, and/or performed by example programmable circuitry to implement the example steering controller of FIGS. 2A-2B, 3, 4, 5, and/or 6.

FIG. 10 is a flowchart representative of example machine readable instructions and/or example operations that may be executed, instantiated, and/or performed by example programmable circuitry to implement the example steering controller of FIGS. 2A-2B, 3, 4, 5, and/or 6.

FIG. 11 is a block diagram of an example processing platform including programmable circuitry structured to execute, instantiate, and/or perform the example machine readable instructions and/or perform the example operations of FIGS. 8, 9, and/or 10 to implement the example steering controller of FIGS. 2A-2B, 3, 4, 5, and/or 6.

In general, the same reference numbers will be used throughout the drawing(s) and accompanying written description to refer to the same or like parts. The figures are not necessarily to scale.

### DETAILED DESCRIPTION

Most vehicles include a powered steering system that utilizes a motor, such as hydraulic motor or electric motor, to assist in applying torque to the steering system, and which reduces the torque input needed by the driver to steer the vehicle. In such vehicles, an electronic control unit utilizes a ‘boost curve’ to determine an assistance torque to be applied to the motor based on driver torque input to a steering wheel. The boost curve defines a static relationship between the driver applied input torque and the assistance torque that the motor produces on the steerable wheels of the vehicle.

Vehicles disclosed herein have self-driving capabilities, referred to herein as a self-driving mode, assisted driving mode, path follower mode, or automated driving mode. When the vehicle is in the self-driving mode, path follower (PF) circuitry (e.g., a PF controller) of the electronic control unit determines a target path for the vehicle and provides a torque request to the motor to automatically control a yaw direction of the vehicle, thereby steering the vehicle along the target path. The PF circuitry receives sensor feedback, such as yaw values, and uses this feedback to further steer the vehicle along the target path. Furthermore, the assistance torque from the boost curve (e.g., based on the input torque from the driver) can be overlayed on the torque request from the PF circuitry. This allows the driver to still provide input and at least partially steer the vehicle while the vehicle is in the self-driving mode. As with power steering, the input torque applied to the steering wheel is equated, by the boost curve, to a larger torque to be applied by the motor. The torque value from the boost curve is combined with the torque from the PF circuitry input to the motor to steer the vehicle.

To provide stiffer and more robust lateral control, vehicles disclosed herein utilize a steering angle interface between the PF circuitry and the steering wheel input rather than a torque interface. In some disclosed examples, the PF circuitry calculates a steering angle to be achieved to cause the vehicle to stay on path, and then converts the steering angle to a torque to be applied by the motor to the steering wheel to achieve the steering angle. As used herein, the terms steering angle and steering wheel angle (SWA) are used interchangeably and mean the angle the steering wheel has been rotated (e.g., by the driver) relative to a neutral or center position. As used herein, the term road wheel angle (RWA) means the angle the steerable wheels, such as the front two wheels, have been rotated (e.g., turned left or right) relative to a neutral or center position. Many of the example operations disclosed herein calculate a steering angle that is used to turn the steering wheel of the vehicle and thereby steer the vehicle. However, in most vehicles, the steering wheel is mechanically connected to the front wheels by a fixed gear relationship (e.g., via a rack and pinion). The geared relationship may be implemented as a fixed steering ratio or a variable steering ratio. For example, for every 12-20° the steering wheel is rotated, the front wheels are turned 1°, and vice versa. Therefore, any of the example operations disclosed herein can instead be described as calculating a road wheel angle, because the steering angle can be equated to the road wheel angle, and vice versa.

In some examples, the PF circuitry provides a PF angle request that corresponds to a target steering angle. However, this angle interface between the PF circuitry and the steering gear (e.g., steerable wheel, gear rack, etc.) imposes a difficulty in overlaying the driver input torque on the PF angle request. That is, the assistance torque from the boost curve cannot be easily combined with the PF angle request. Thus, in these angle-based follower platforms, the boost curve is typically deactivated during self-driving mode such that there is no torque overlay between the torque output of the angle control (e.g., PF circuitry) and the boost curve output. This increases robustness of the path follower operation of the vehicle because torque noise from amplification of the input torque is removed. However, this also presents a need for driver input to be overlayed at the angle request level rather than the torque level.

Disclosed herein are example steering controllers and associated methods that use a virtual boost curve (VBC) to determine a steering angle, referred to herein as a VBC angle request, based on the driver torque input. In some examples, the steering controller determines a delta or incremental steering angle based on at least the driver torque input, and adds the delta angle to a current SWA to generate the VBC angle request. The example steering controller combines the VBC angle request with the PF angle request to generate a final steering angle request. Therefore, rather than a torque based boost curve output, the VBC is used to determine or output a steering angle, which is then combined with the PF angle request. An angle controller of the example steering controller converts the final steering angle request to a final torque request, which the motor of the steering system uses to adjust the steering angle of the steering wheel to steer the vehicle along the intended path.

In some examples, the steering controller includes VBC circuitry and/or implements a VBC method to enable manual steering while still being in the self-driving mode. The example steering controller disclosed herein uses the input torque (e.g., torsion bar (T-bar) torque) to generate an incremental angle, adds the incremental angle to the current SWA, and generates a VBC request that gets blended with the PF request and used to generate a final angle request for the angle controller. In some examples, the torque source is the raw T-Bar torque and not a filtered torque, such as a Kalman filter based driver torque. That is, examples disclosed herein use a raw torque input to generate the VBC angle request because the lag associated with filtered torques creates a lag in the steering feel using the VBC. Examples disclosed herein also combine the VBC angle request with the PF angle request to generate the final angle request. In some examples, the VBC angle request and the PF angle request are combined after the VBC angle request is properly tuned.

Examples disclosed herein provide methods and apparatus to configure a return-to-center (R2C) angle for a steering wheel that biases the steering wheel toward a desired trajectory (e.g., a trajectory plan, a target path) identified by the self-driving system. Examples disclosed herein cause a torque feel during self-driving to be a combination of a return to center-based pushback and through pushback from the PF angle request. This combination in the torque feel can create an intuitive steering feel for the driver, where the driver applies torque while navigating a curve only to create and manage a bias and not to hold the curve. Additionally, examples disclosed herein provide an active R2C determination that provides a crisp steering feel and avoids potential delays in adjusting the final angle request with small modulations in the engaged interaction state.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, the terms “desired trajectory,” “trajectory plan,” and “target path” encompass a path for a vehicle to follow that is determined based on at least one of (i) a reference path or (ii) at least a current trajectory (e.g., an instantaneous trajectory) of the vehicle and a lookahead distance (e.g., a predetermined lookahead distance), which can be based on the vehicle speed. The reference path can be a map-based or vision-based path for the vehicle to follow that is time and vehicle position independent. For example, when the vehicle is in a lane keep mode or state, in which a maneuver being performed maintains the vehicle in the same lane it currently occupies, the “trajectory plan” is based on the reference path and not the current trajectory or the lookahead distance. Further, when the vehicle is in a lane change mode or state, the “trajectory plan” is based on the reference path, the current trajectory (e.g., an instantaneous trajectory) of the vehicle, and the lookahead distance.

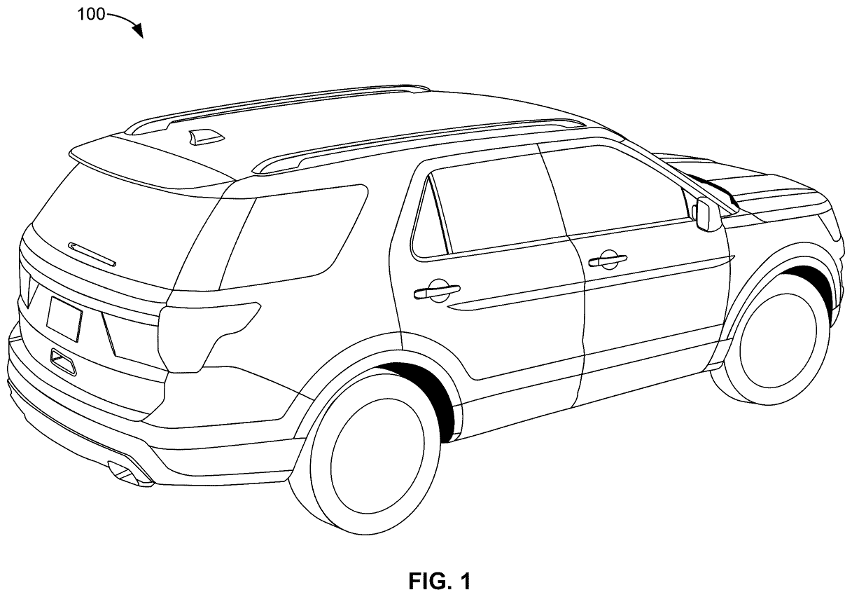

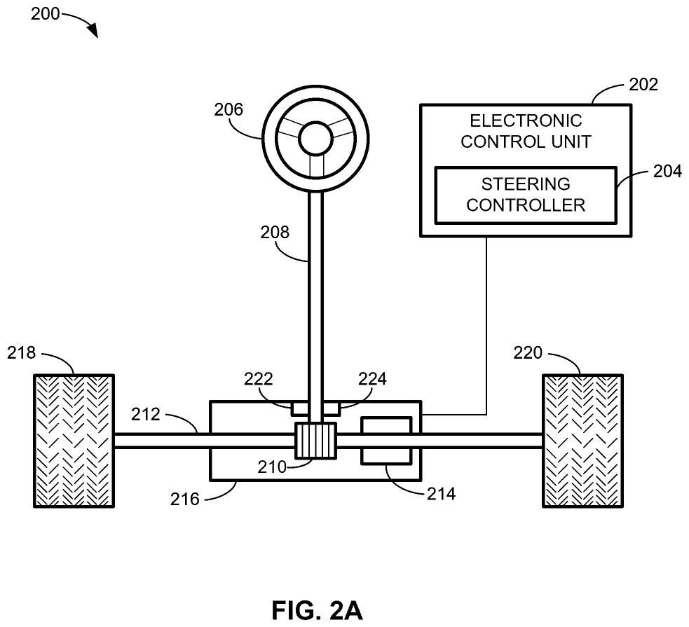

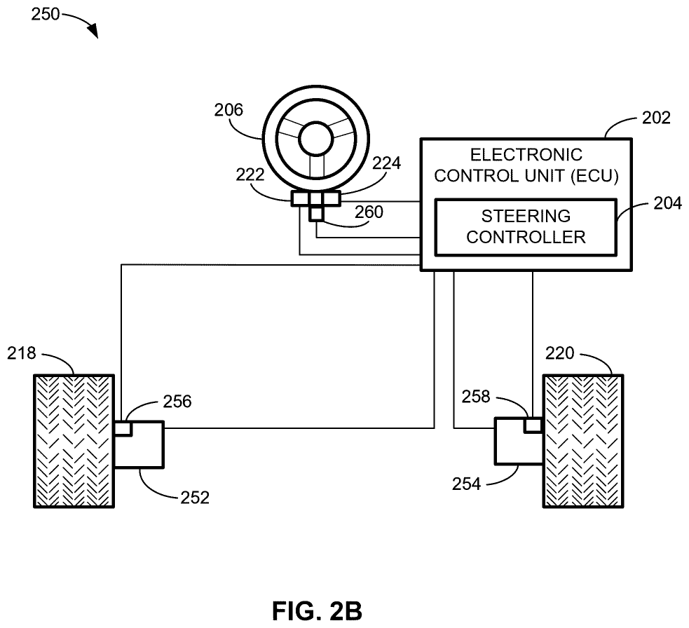

FIG. 1 illustrates an example vehicle 100 in which the examples disclosed herein can be implemented. The example vehicle 100 includes an example steering controller, shown in further detail herein, that can operate to automatically steer and/or direct the vehicle along a target path. Such automated operation is referred to herein as a path follower (PF), an assisted driving mode, or self-driving mode or operation. In some examples, the assisted driving mode can be activated and deactivated by the driver by pressing or a button and/or interacting with a display in the vehicle. During the assisted driving mode, the steering controller of the vehicle 100 generates a PF angle request (e.g., independent of driver input) to direct the vehicle 100 along a target path. If the driver applies a torque input to the steering wheel of the vehicle 100, the steering controller generates a VBC angle request. The steering controller combines the VBC angle request with the PF angle request to generate a final angle request, and converts the final angle request to a torque request or output to be used to adjust the steering angle of the vehicle 100. Additionally, the steering controller determines a return-to-center (R2C) angle that biases the steering angle the vehicle 100 to a desired trajectory, as discussed in further detail herein. For example, the R2C angle can cause the vehicle 100 to follow a curvature associated with the desired trajectory, as opposed to merely returning a heading of the vehicle to a straight or neutral position. Further description of the steering controller of the vehicle 100 is provided below in connection with FIGS. 2-9. The illustrated example of the vehicle 100 of FIG. 1 is merely an example of a sport utility vehicle (SUV) in which examples disclosed herein can be implemented. However, examples disclosed herein can also be implemented in connection with other types of vehicles (e.g., pickup trucks, sedans, semi-trucks, etc.).

FIG. 2A is a schematic illustration of an example steering system 200 that can be implemented in the example vehicle 100 of FIG. 1. In the illustrated example of FIG. 2A, the steering system 200 includes an electronic control unit 202 including a steering controller 204, a steering wheel 206, a steering column 208, a pinion 210, a gear rack 212, a steering motor 214, a housing 216, a first steerable wheel 218, a second steerable wheel 220, a torque sensor 222, and an SWA sensor 224. The example steering wheel 206 is mechanically connected to the first steerable wheel 218 and the second steerable wheel 220 (e.g., the front wheels of the vehicle 100 (FIG. 1). In particular, the steering wheel 206 is coupled to the first steerable wheel 218 and the second steerable wheel 220 via the steering column 208, the pinion 210, and the rack 212. Thus, as the driver of the vehicle 100 of FIG. 1 inputs torque to adjust the SWA of the steering wheel 206, the steering angle of the first and second steerable wheels 218, 220 is correspondingly adjusted (e.g., turned left or right). The rack 212 and the pinion 210 may implement a fixed gear ratio or a variable gear ratio. In some examples, the steering column is a single shaft extending between the steering wheel 206 and the pinion 210. In other examples, the steering column 208 is a mechanical linkage including two or more interconnected shaft segments. For example, the steering column 208 can include a first steering shaft coupled to a second steering shaft via a universal joint (U-joint). Thus, the steering column 208 can be straight and/or angled between the steering wheel 206 and the steerable wheels 218, 220. In some examples, the vehicle 100 includes a steer-by-wire system, as discussed in connection with FIG. 2B.

In the illustrated example of FIG. 2A, the pinion 210 is coupled to and/or interfaces with the gear rack 212. For example, gear teeth of the pinion 210 are meshed with gear teeth of the gear rack 212. Thus, as the pinion 210 rotates based on the driver input torque to the steering wheel 206, the gear rack 212 translates laterally relative to the steering column 208. In some examples, the pinion 210 is positioned within the housing 216. In some examples, the pinion 210 is positioned outside of the housing 216.

In the illustrated example of FIG. 2A, the steering system 200 includes the motor 214. The motor 214 is operatively coupled to the steering wheel 206 and the first and second steerable wheels 218, 220. For example, the motor 214 can be coupled to the gear rack 212. When activated, the motor 214 moves or translates the gear rack 212, which thereby turns or angles the steering wheel 206 as well as the steerable wheels 218, 220. Thus, the motor 214 operates to adjust the steering angle of the steering wheel 206 and, thus, also adjusts the road wheel angle of the first and second steerable wheels 218, 220 to steer the vehicle 100. In some examples, the motor 214 can be used to provide power steering assistance. For example, in a traditional driving mode, based on torque input to the steering wheel 206, the electronic control unit 202 may activate the motor 214 to provide additional torque assistance for steering the vehicle 100. Additionally, the motor 214 can be activated to control the steering angle of the steering wheel 206 while the vehicle 100 is in an assisted driving mode. The steering controller 204 can also control the motor 214 to bias the steering wheel 206 towards a R2C angle associated with a trajectory plan or a reference path for the vehicle 100. As discussed in further detail herein, the steering controller 204 can provide a PF angle request and/or a torque request to the motor 214 to cause the motor 214 to adjust the steering angle accordingly.

The example steering controller 204 can operate in an assisted driving mode to control the motor 214 and adjust the steering angle of the vehicle 100, example operations of which are disclosed in further detail herein. The steering controller 204 of FIG. 2A may be instantiated (e.g., creating an instance of, bring into being for any length of time, materialize, implement, etc.) by programmable circuitry such as a Central Processor Unit (CPU) executing first instructions. Additionally or alternatively, the steering controller 204 of FIG. 2A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2A may, thus, be instantiated at the same or different times. Some or all of the circuitry of FIG. 2A may be instantiated, for example, in one or more threads executing concurrently on hardware and/or in series on hardware. Moreover, in some examples, some or all of the circuitry of FIG. 2A may be implemented by microprocessor circuitry executing instructions and/or FPGA circuitry performing operations to implement one or more virtual machines and/or containers.

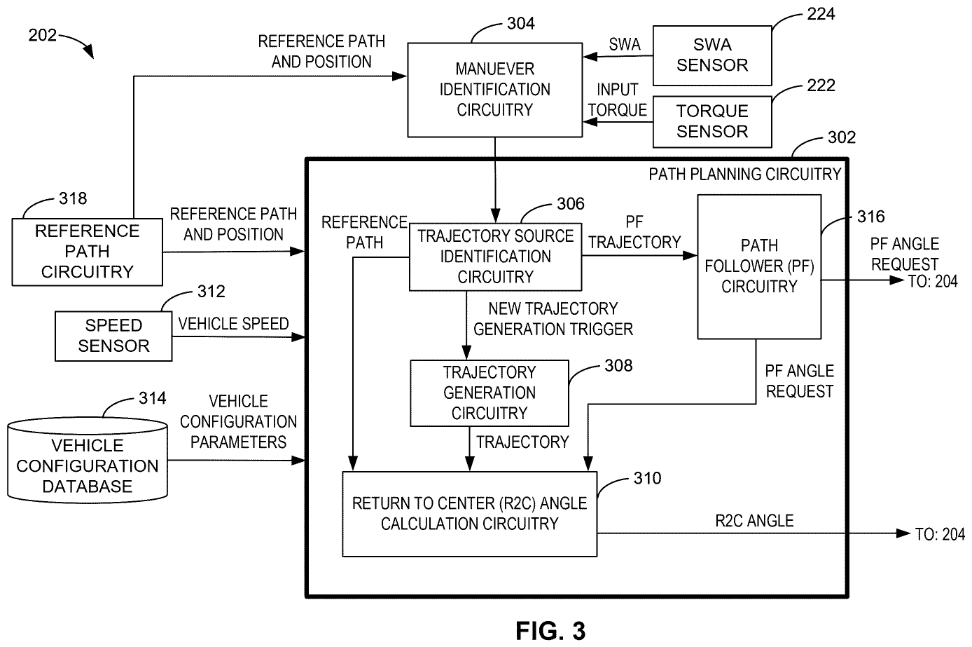

In some examples, the steering controller 204 of FIG. 2A includes instructions and programmable circuitry to execute the instructions to determine a R2C angle that enables the vehicle to react accordingly to different driving maneuvers. The R2C angle utilization helps reduce a delay in returning to a desired trajectory after performing an evasive maneuver. Further, the steering controller 204 can adjust a steering wheel angle based at least partially on the determined R2C angle. For example, the steering controller 204 can generate a VBC angle request based on the determined R2C angle and a torque input to a steering wheel 206 of the example vehicle 100 of FIG. 1. Furthermore, the steering controller 204 determines an angle blend weight based on the torque input and a speed of the vehicle 100. The example steering controller 204 can determine a final angle request based on a combination of the VBC angle request, a PF angle request, and the angle blend weight. The example steering controller 204 converts the final angle request to a torque request to be used to adjust the steering angle of the vehicle 100. The steering controller 204 can determine a R2C angle request based on the PF angle request, the torque input, a vehicle speed, a vehicle configuration (e.g., a steering ratio, a wheelbase, etc.), and/or a maneuver to be performed by the vehicle 100, as discussed in further detail below. Further descriptions regarding the structure and operations of the steering controller 204 are described below in connection with FIGS. 3-11.

In the illustrated example of FIG. 2A, the steering system 200 includes the torque sensor 222 to detect or measure an input torque on the steering wheel 206. For example, when the driver turns or attempts to turn the steering wheel 206 during self-driving mode of the vehicle 100 of FIG. 1, the torque sensor 222 detects the torque input. In some instances, when in the self-driving mode, the torque applied by the motor 214 is quite powerful. However, the torque sensor 222 can still detect a torque applied at the steering wheel 206, which can then be converted into a desired steering angle, disclosed in further detail herein. In some examples, the steering controller 204 analyzes the sensor output to determine the torque input by the driver. The example torque sensor 222 can detect a static torque input at a point in time and/or a dynamic torque input over a period of time. As such, the torque sensor 222 can be a reaction torque sensor including a stationary or non-rotating transducer. The example torque sensor 222 can also be a rotary torque sensor including rotary transducers to measure torque input. In some examples, the torque sensor 222 is coupled to a torsion bar (T-bar) of the steering system 200. The torque on the T-bar can be equated to a torque applied at the steering wheel 206. In other examples, the torque sensor 222 is connected at another location of the steering system 200 (e.g., at the steering wheel 206).

In the illustrated example of FIG. 2A, the steering system 200 includes the SWA sensor 224 to detect a SWA of the steering wheel 206, the steering column 208, and/or the pinion 210. The example SWA sensor 224 can be coupled to the steering column 208 and/or the pinion 210 in a contacting or non-contacting arrangement. In some examples, the SWA sensor 224 is implemented as to a rotary position sensor, which enables precise angle measurements of the steering wheel 206. For example, the SWA sensor 224 can transform mechanical rotary positions into electrical signals. Thus, the example SWA sensor 224 can correspond to an incremental encoder or a rotary encoder that detects changes in SWA, angular velocity, and/or direction of rotation of the steering wheel 206. In some examples, the steering controller 204 obtains the SWA from the SWA sensor 224 in the form of a digital signal that the SWA sensor 224 (e.g., mechanical motion sensor) creates from a motion of the steering wheel 206, the steering column 208, and/or the pinion 210.

FIG. 2B is a schematic illustration of an example steering system 250 that can be implemented in the example vehicle 100 of FIG. 1. In the illustrated example of FIG. 2B, the steering system 250 includes the electronic control unit 202, the steering controller 204, the steering wheel 206, the first steerable wheel 218, the second steerable wheel 220, the torque sensor 222, and the SWA sensor 224 of FIG. 2A. The steering system 250 also includes a first steerable wheel motor 252, a second steerable wheel motor 254, a first steerable wheel position sensor 256, a second steerable wheel position sensor 258, and a torque feedback motor 260 (e.g., a steering wheel motor 260).

In the illustrated example of FIG. 2B, the torque sensor 222 and the SWA sensor are operatively coupled to the steering wheel 206 to detect or measure the input torque on the steering wheel 206 and the SWA of the steering wheel 206, respectively. The first steerable wheel motor 252 is operatively coupled to the first steerable wheel 218 to control and angular position thereof. The second steerable wheel 254 is operatively coupled to the second steerable wheel 220 to control an angular position thereof. The first steerable wheel motor 252 and the second steerable wheel motor 254 can be implemented by electric motors and/or electromechanical actuators. In some other examples, the first and second steerable wheel motors 252, 254 can be implemented by hydraulic motors.

In the illustrated example of FIG. 2B, the first steerable wheel position sensor 256 is operatively coupled to the first steerable wheel 218 and/or the first steerable wheel motor 252. The second steerable wheel position sensor 258 is operatively coupled to the second steerable wheel 220 and/or the second steerable wheel motor 254. The first steerable wheel positions sensors 256, 258 detect or measure an angular position and/or a rotational speed of the first and second steerable wheels 218, 220.

In the illustrated example of FIG. 2B, the torque feedback motor 260 is operatively coupled to the steering wheel 206 to provide torque feedback (e.g., steering feel). For example, the torque feedback motor 260 can be implemented by a motor operatively coupled to the steering wheel 206.

In the illustrated example of FIG. 2B, the ECU 202 identifies a driver input based on signals from the torque sensor 222 and/or the SWA sensor 224. The ECU 202 determines and transmits control signals to the first steerable wheel motor 252 and the second steerable wheel motor 254 based on the driver input. Additionally or alternatively, the ECU 202 can determine the control signals based on a final angle request determined by the steering controller 204, as discussed in further detail below. Further, the ECU 202 can monitor the first steerable wheel positions sensors 256, 258 for real-time feedback on the actual position and movement of the steerable wheels 218, 220 to ensure accurate and responsive steering is maintained. In some examples, the ECU 202 determines the torque feedback (e.g., amplitude and direction) to be provided by the torque feedback motor 260, as discussed in further detail below. In some examples, the ECU 202 causes the torque feedback motor 260 to adjust the SWA via the torque feedback motor 260 to match the final angle request in an assisted driving mode.

FIG. 3 is a block diagram of a portion of the ECU 202 including example path planning circuitry 302 associated with the vehicle 100 to determine a R2C angle. The ECU 202 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the ECU 202 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

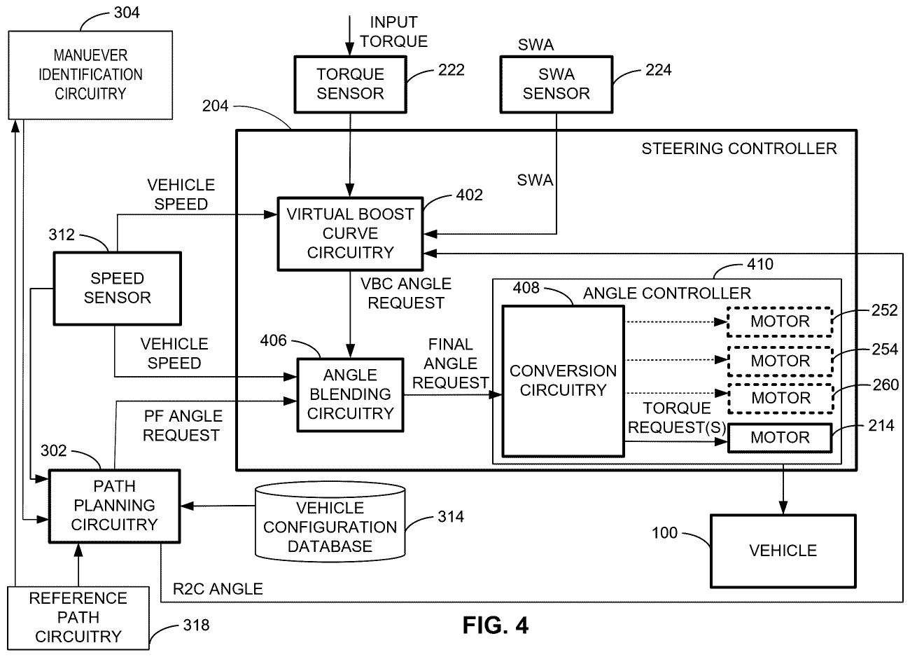

In this example, the path planning circuitry 302 is implemented by a portion of the ECU 202 distinct from and communicatively coupled to the steering controller 204 path planning circuitry 302, as discussed in connection with FIG. 4. For example, the path planning circuitry 302 and/or one or more other portions of the ECU 202 depicted in FIG. 3 may be implemented by another controller of the ECU 202. Alternatively, the path planning circuitry 302 and/or one or more other portions of the ECU 202 depicted in FIG. 3 can be implemented by the steering controller 204.

In the illustrated example of FIG. 3, the path planning circuitry 302 includes trajectory source identification circuitry 306, trajectory generation circuitry 308, return to center (R2C) angle calculation circuitry 310, and example path follower (PF) circuitry 316. The path planning circuitry 302 can obtain a vehicle speed, which may be measured by a speed sensor 312 of the vehicle 100; vehicle configuration parameters (e.g., a wheelbase parameter, a steering ratio parameter, an understeer gradient parameter, etc.), which can be stored in a vehicle configuration database 314; and/or a reference path and position (e.g., a geographic position) of the vehicle 100, which can be determined by reference path circuitry 318.

When the vehicle 100 is in the assisted driving mode, the example reference path circuitry 318 determines a reference path (e.g., a target path) for the vehicle 100 to follow. The reference path is a vector (e.g., an x-y vector) that can be used to determine a steering angle of the vehicle 100 to steer or direct the vehicle 100 along a target path and/or to determine a return to center (R2C) angle for the steering wheel 206, as discussed in further detail below. The reference path circuitry 318 can utilize a global positioning system (GPS) and/or the like to identify the position of the vehicle 100. The reference path circuitry 318 communicates the reference path and the position of the vehicle 100 to the path planning circuitry 302.

In the illustrated example of FIG. 3, the example maneuver identification circuitry 304 determines a type of maneuver to be performed by the vehicle 100. The maneuver identification circuitry 304 can determine whether the vehicle 100 is performing evasive maneuver (e.g., the vehicle 100 is in an evasive maneuver mode or state), a lane keep maneuver (e.g., the vehicle 100 is in a lane keep mode or state), or a lane change maneuver (e.g., the vehicle 100 is in a lane change mode or state). In some examples, the maneuver identification circuitry 304 determines the type of maneuver based on an input from the driver (e.g., a turn signal indication), the reference path and position determined by the reference path circuitry 318, and/or an input from another component of the ECU 202. For example, the maneuver identification circuitry 304 can determine that the vehicle 100 is to perform a lane change maneuver based on the reference path and/or activation of a turn signal. In some examples, the maneuver identification circuitry 304 identifies an incoming evasive maneuver based on the reference path.

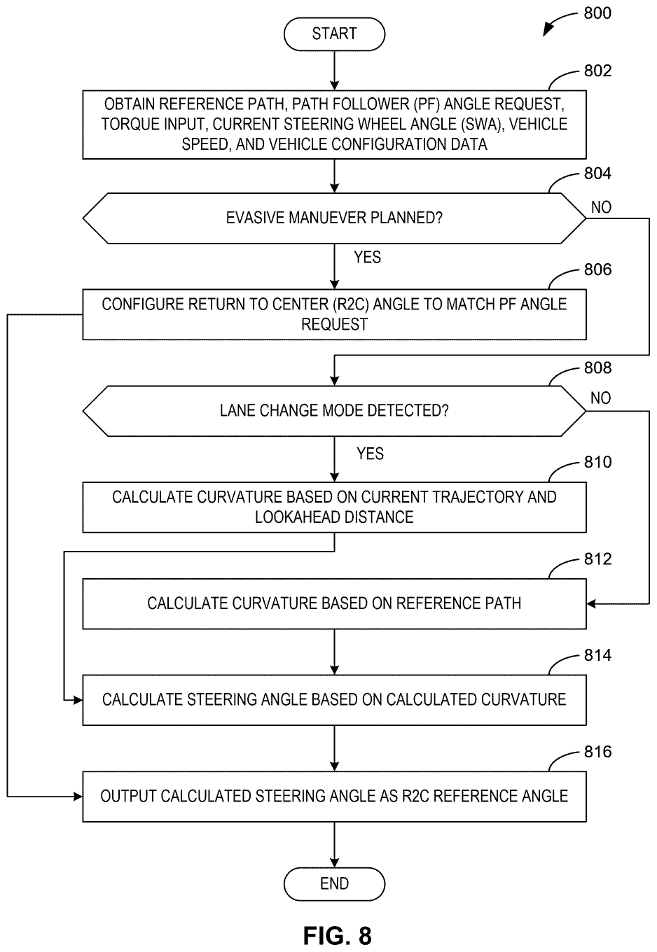

In some examples, the maneuver identification circuitry 304 identifies an incoming evasive maneuver in response to the reference path having a fast deviation from a current heading of the vehicle 100 (e.g., a sudden movement within a lane or the like). In some other examples, the maneuver identification circuitry 304 can determine that the driver is performing an evasive maneuver in response to detecting a steering wheel acceleration that satisfies (e.g., is greater than, is greater than or equal to) an acceleration threshold. The maneuver identification circuitry 304 can determine the steering wheel acceleration based on a change in the SWA and/or the torque input. Specifically, high steering wheel accelerations during an evasive maneuver can cause inertia of the upper steering column to twist and show a torque input that exceeds a driver interaction activation threshold implemented by the steering controller 204, which results in a switch from a fully autonomous driving mode to a shared driving mode between the driver and the steering controller 204. In the shared driving mode, an input from the PF circuitry 316 has a reduced effect on the final steering angle. However, the input from PF circuitry 316 can still correspond to the target path intended by the driver after the evasive maneuver. By detecting the evasive maneuver, the path planning circuitry 302 can cause the steering controller 204 to react appropriately to the evasive maneuver by determining the R2C angle based on the PF angle request. In some examples, the maneuver identification circuitry 304 is instantiated by programmable circuitry executing maneuver identification instructions and/or configured to perform operations such as those represented by the flowchart of FIG. 8.

The example path planning circuitry 302 determines a R2C angle to be implemented at the steering wheel 206 based on the vehicle configuration parameters, the vehicle speed, and/or a trajectory plan (e.g., a target path). The trajectory plan used to determine the R2C angle can correspond to the reference path determined by the reference path circuitry 318 and/or another trajectory determined by the path planning circuitry 302, as discussed in further detail below. The R2C angle represents a desired SWA associated with the target path that the vehicle 100 is desired to follow. As such, the path planning circuitry 302 provides a natural and intuitive steering feel, even on curved roads or during maneuvers like lane changes. Additionally, in assisted driving operations where the PF circuitry 316 has low authority (e.g., is being at least partially ignored as a result a driver input), the path planning circuitry 302 enables the R2C angle to reflect a non-neutral angle associated with a desired trajectory during non-straight maneuvers.

The path planning circuitry 302 includes the trajectory source identification circuitry 306 to determine a source for a trajectory plan (e.g., target path) for the vehicle 100 based on the type of maneuver being performed by the vehicle 100. In some examples, when the maneuver identification circuitry 304 determines that the vehicle 100 is performing an evasive maneuver, the trajectory source identification circuitry 306 determines a path follower (PF) trajectory. In some examples, another component of the ECU 202 and/or the path planning circuitry 302 determines the PF trajectory. The PF trajectory is represented by a vector (e.g., an x-y vector). The trajectory source identification circuitry 306 communicates the PF trajectory to the PF circuitry 316, which determines a path follower (PF) angle request corresponding to the determined trajectory. Further, the trajectory source identification circuitry 306 causes the PF circuitry 316 to communicate the PF angle to the R2C angle calculation circuitry 310, which utilizes the PF angle request to determine the R2C angle when the vehicle is performing the evasive maneuver. Thus, the trajectory source identification circuitry 306 causes the source for the trajectory plan to correspond to the PF angle request.

In the illustrated example of FIG. 3, when the maneuver identification circuitry 304 determines that the vehicle 100 is performing a lane keep maneuver, the trajectory source identification circuitry 306 causes the R2C angle calculation circuitry 310 to determine the R2C angle based on the reference path. For example, the trajectory source identification circuitry 306 can relay the reference path and position from the reference path circuitry 318 to the R2C angle calculation circuitry 310. As mentioned above, the reference path corresponds to a trajectory in the form of a vector (e.g., an x-y vector) similar to the PF trajectory. However, the reference path vector differs from the PF trajectory vector when the vehicle 100 is not currently located on the reference path.

In the illustrated example of FIG. 3, when the maneuver identification circuitry 304 determines that the vehicle 100 is performing a lane change maneuver, the trajectory source identification circuitry 306 causes the trajectory generation circuitry 308 to determine the trajectory plan for the vehicle 100. That is, in the lane change state, the trajectory source identification circuitry 306 triggers the trajectory generation circuitry 308 to determine a trajectory plan that differs from the PF angle request and the reference path. In some examples, the trajectory source identification circuitry 306 and/or the maneuver identification circuitry 304 communicates an identified lane change state (e.g., a lane change state versus a lane keep state) to the trajectory generation circuitry 308. In some examples, the trajectory source identification circuitry 306 is instantiated by programmable circuitry executing trajectory source identification instructions and/or configured to perform operations such as those represented by the flowchart of FIG. 8.

When the vehicle 100 is in the assisted driving mode, example path follower (PF) circuitry 316 determines a PF angle request, which is used to adjust the steering angle of the vehicle 100 to steer or direct the vehicle 100 along a target path. In FIG. 3, the PF circuitry 316 is shown as separate from the steering controller 204. For example, the PF circuitry 316 may be implemented by another controller of the ECU 202. However, in other examples, the PF circuitry 316 may be part of the steering controller 204. When the driver of the vehicle 100 does not interact with the steering wheel 206 (e.g., zero input torque) during the self-driving mode, the PF circuitry 316 controls the yaw, direction, and/or steering angle of the vehicle 100. For example, when the driver input torque is zero while the vehicle 100 is operating in the assisted driving mode, the final angle request may be comprised of only the PF angle request. In some examples, the PF circuitry 316 determines the PF angle request based on a target path of the vehicle 100, a velocity of the vehicle 100, a current steering angle of the steering wheel 206 of FIG. 2A, and/or a projected path of the vehicle 100. The target path determined by the PF circuitry 316 can be map-based and/or vision-based. The path planning circuitry 302 obtains the target path (e.g., the map-based reference path and/or the vision-based reference path) from the PF circuitry 316 and/or another component of the ECU 202. In some examples, the PF circuitry 316 is instantiated by programmable circuitry executing PF instructions and/or configured to perform operations such as those represented by the flowchart(s) of FIGS. 8 and/or 9.

The path planning circuitry 302 includes the trajectory generation circuitry 308 to determine the trajectory plan for the vehicle 100 in response to being triggered to do so by the trajectory source identification circuitry 306. For example, the trajectory generation circuitry 308 can determine a curvature that the vehicle 100 is to follow in the trajectory plan. In some examples, the trajectory generation circuitry 308 determines the curvature when the vehicle 100 is performing a lane change, and the reference path circuitry 318 determines the curvature when the vehicle is maintaining the same lane. In some other examples, the trajectory generation circuitry 308 determines the curvature in both the lane keep and the lane change state. For example, the trajectory source identification circuitry 306 can communicate the type of maneuver being performed to the trajectory generation circuitry 308. In such examples, the trajectory generation circuitry 308 determines a manner according to which the curvature is to be determined based on the type of maneuver being performed.

When the vehicle 100 is to perform a lane change, the trajectory generation circuitry 308 calculates the trajectory plan for the vehicle 100 based on a current trajectory (e.g., an instantaneous trajectory) of the vehicle 100, an instantaneous position of the vehicle 100, and a lookahead distance (e.g., a predetermined lookahead distance). The lookahead distance can be a function of time and the vehicle speed, such as a distance that the vehicle 100 will have traversed in one second of time at the instantaneous vehicle speed. For example, the trajectory generation circuitry 308 can identify the instantaneous trajectory based on a rear axle spatial path. The trajectory generation circuitry 308 can determine the rear axle spatial path based on information from various sensors (e.g., wheel speed sensors, the SWA sensors, accelerometers, yaw rate sensors, GPS, etc.). In some examples, another component of the ECU 202 determines the rear axle spatial path, which can be communicated to the trajectory generation circuitry 308. In some examples, the trajectory generation circuitry 308 can calculate the curvature associated with the trajectory plan based on pure pursuit law, which is expressed below in Equation 1 and Equation 2:

$$γ = \frac{2 * sin Δθ}{{l}_{d}} ; and \qquad Equation 1$$

$$Δθ = {tan}^{- 1} ( \frac{{y}_{2} - {y}_{1}}{{x}_{2} - {x}_{1}} ) - {θ}_{1} . \qquad Equation 2$$

In Equation 1, y is the curvature, l_{d} is the lookahead distance, and Δθ is the yaw difference. The yaw difference, Δθ, is calculated using Equation 2. In Equation 2, (x₂, y₂) is a lookahead point, θ₁ is the rear axle spatial path (e.g., a first trajectory point yaw), and (x₁, y₁) is the instantaneous position of the vehicle 100 (e.g., a first trajectory point).

In some examples, when the vehicle 100 is maintaining a same lane currently occupied by the vehicle 100 (e.g., in a lane keep state), the reference path circuitry 318 and/or the trajectory generation circuitry 308 determine a vector representative of a curvature associated with the reference path. To determine the curvature of the trajectory plan when the vehicle 100 is maintaining the same lane currently occupied by the vehicle 100, the reference path circuitry 318 and/or the trajectory generation circuitry 308 determine whether a source of the reference path is map-based or vision-based. When the source is map-based, the reference path circuitry 318 and/or the trajectory generation circuitry 308 determine the curvature of the trajectory plan based on a map-based reference path associated with the current lane occupied by the vehicle 100 and a lookahead distance.

In the illustrated example of FIG. 3, when the source is vision-based, the reference path circuitry 318 and/or the trajectory generation circuitry 308 determine the curvature based on polynomial coefficients (e.g., cubic polynomial coefficients, vision path coefficients, etc.) that correspond to the vision-based reference path at the lookahead distance. For example, the reference path circuitry 318 and/or the trajectory generation circuitry 308 can determine the curvature from the vision-based polynomial coefficients using Equations 3, 4, and 5.

$${y}^{′} = 3 * coeffs \cdot cubic * {l}_{d}^{2} + 2 * coeffs \cdot quadratic * {l}_{d} + coeffs \cdot linear ; \qquad Equation 3$$

$${y}^{″} = 6 * coeffs \cdot cubic * {l}_{d} + 2 * coeffs \cdot quadratic ; and \qquad Equation 4$$

$$curvature = - \frac{{y}^{″}}{{( 1 + {y}^{′2} )}^{1.5}} \qquad Equation 5$$

In Equations 3-5, y′ is a first derivative of the polynomial function that represents the vision-based path; coeffs.cubic, coeffs.quadratic, and coeffs.linear are polynomial coefficients from the polynomial function; l_{d} is the lookahead distance; y″ is the second derivative of the polynomial function; and curvature is the determined curvature associated with the trajectory plan.

In the illustrated example of FIG. 3, the trajectory source identification circuitry 306, the trajectory generation circuitry 308, the PF circuitry 316, and/or the reference path circuitry 318 communicate the determined trajectory plan to the R2C angle calculation circuitry 310. In FIG. 3, the trajectory generation circuitry 308 is shown as part of the path planning circuitry 302. However, in other examples, the trajectory generation circuitry 308 can be implemented in another area of the vehicle 100 communicatively coupled to the path planning circuitry 302. For example, the path planning circuitry 302 may be implemented by a distinct portion of the steering controller 204 and/or another controller of the ECU 202. In such examples, an output of the trajectory generation circuitry 308 can be transmitted to the path planning circuitry 302. In some examples, the trajectory generation circuitry 308 is instantiated by programmable circuitry executing trajectory generation instructions and/or configured to perform operations such as those represented by the flowchart of FIG. 8.

The path planning circuitry 302 includes the R2C angle calculation circuitry 310 to calculate the R2C angle. When the maneuver identification circuitry 304 determines that the vehicle 100 is performing an evasive maneuver, the R2C angle calculation circuitry 310 configures the R2C angle to be equivalent to the PF angle request. For example, the R2C angle calculation circuitry 310 can cause the R2C angle to match a steering angle in the PF angle request.

When maneuver identification circuitry 304 determines that the vehicle 100 is performing a lane keep maneuver or a lane change maneuver, the R2C angle calculation circuitry 310 calculates the R2C angle based on the determined curvature of the trajectory plan, the wheelbase, the vehicle speed, the understeer gradient, and the steering ratio. For example, the R2C angle calculation circuitry 310 can access the vector representative of the curvature of the trajectory plan from the trajectory source identification circuitry 306, the trajectory generation circuitry 308, and/or the reference path circuitry 318. Further, the R2C angle calculation circuitry 310 can determine a road wheel angle in radians, roadWheelAngle.rad using Equation 6.

$$roadWheelAngle \cdot rad = {tan}^{- 1} ( ( wheelbase \cdot m + understeerGradientRad \cdot mps 2 * velocity \cdot {mps}^{2} ) * curvature \cdot rad pm ) \qquad Equation 6$$

In Equation 6, wheelbase.m is the wheelbase of the vehicle 100 in meters; understeerGradientRad.mps2 is the understeer gradient of the vehicle 100 in radians multiplied by meters-per-second-squared; velocity.mps is the speed of the vehicle 100 in meters-per-second; and curvature_radpm is the determined curvature associated with the trajectory plan in radians-per-meter. Further, the R2C angle calculation circuitry 310 converts the roadWheelAngle.rad from radians to degrees and multiply the road wheel angle in degrees by the steering ratio of the vehicle 100 to obtain the R2C angle associated with the trajectory plan. In some examples, the R2C angle calculation circuitry 310 is instantiated by programmable circuitry executing angle calculation instructions and/or configured to perform operations such as those represented by the flowchart of FIG. 8.

The path planning circuitry 302 communicates the R2C angle to another component of the steering controller 204 and/or the ECU 202. For example, the path planning circuitry 302 can communicate the R2C angle to a software driver that allows a Vehicle Communication Module (VCM) to communicate with a Controller Area Network (CAN) bus communicatively coupled to another component of the steering controller 204 and/or the ECU 202. Thus, the steering controller 204 can utilize the R2C angle to determine a position and/or torque to be provided by the motor 214 (FIG. 2A) or the torque feedback motor 260 (FIG. 2B) in steering the vehicle 100 in an assisted driving mode. An example manner according to which the vehicle 100 can utilize the determined R2C angle is discussed in further detail below. However, it should be understood that the determined R2C angle can be utilized in a different manner to facilitate assisted driving. For example, the path planning circuitry 302 can provide the determined R2C angle to the motor 214 or the torque feedback motor 260, which can cause the driver to encounter a mirrored torque resistance on opposite sides of the R2C angle. That is, the motor 214 or the torque feedback motor 260 provides a counteraction torque resistance that acts in an opposite direction from the torque input relative to the R2C angle to bias the steering angle towards the R2C angle. Thus, the path planning circuitry 302 enables the motor 214 or the torque feedback motor 260 to provide a more intuitive steering feel in assisted driving, especially when the R2C angle is non-zero.

FIG. 4 is an example block diagram of the steering controller 204 of FIGS. 2A-2B. When the vehicle 100 is in the assisted driving mode, the steering controller 204 operates to control the motor 214 (FIG. 2A) or the first steerable wheel motor 252, the second steerable wheel motor 254, and/or the torque feedback motor 260 (FIG. 2B) to adjust the steering of the vehicle 100 and thereby steer the vehicle 100 along a target path. The steering controller 204 can also control the motor 214 or the first steerable wheel motor 252, the second steerable wheel motor 254, and/or the torque feedback motor 260 (and, thus, the steering angle) based on driver input torque during the assisted driving mode, such as when the driver attempts to manually turn the steering wheel 206 (FIGS. 2A-2B). When the vehicle 100 includes the steering system 200 of FIG. 2A, the steering controller 204 includes or is in communication with the motor 214. When the vehicle 100 includes the steering system 250 of FIG. 2B, the steering controller 204 includes or is in communication with the first steerable wheel motor 252, the second steerable wheel motor 254, and/or the torque feedback motor 260. In some examples, the steering controller 204 is implemented in the electronic control unit 202 of FIGS. 2A-2B. Additionally or alternatively, the steering controller 204 can be implemented in another control system, control unit, and/or computing system of the vehicle 100.

In the illustrated example of FIG. 4, the steering controller 204 includes example virtual boost curve circuitry 402 (VBC circuitry 402), example angle blending circuitry 406, and example conversion circuitry 408. The conversion circuitry 408 and the motor 214 (FIG. 2A) or the first steerable wheel motor 252, the second steerable wheel motor 254, and/or the torque feedback motor 260 (FIG. 2B) may be referred to as an angle controller 410. That is, when the vehicle 100 includes the steering system 200 of FIG. 2A, the angle controller 410 includes the motor 214. When the vehicle 100 includes the steering system 250 of FIG. 2B, the angle controller 410 includes the first steerable wheel motor 252, the second steerable wheel motor 254, and/or the torque feedback motor 260. As mentioned above, the torque sensor 222 outputs sensor signals corresponding to raw T-bar torque, which is indicative of driver input torque applied to with the steering wheel 206. The path planning circuitry 302 determines the R2C angle based on a maneuver to be performed by the vehicle 100 identified by the maneuver identification circuitry 304, the reference path from the reference path circuitry 318, the vehicle speed from the speed sensor 312, and/or vehicle configuration parameters (e.g., a wheelbase, an understeer gradient, a steering ratio, etc.) accessed via the vehicle configuration database 314, as discussed above in connection with FIG. 3.

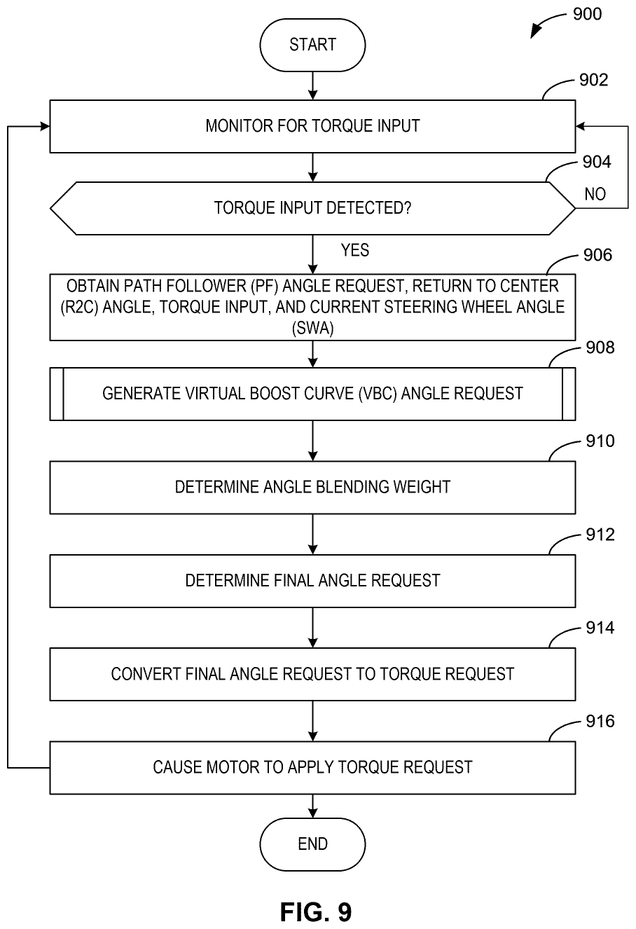

In the illustrated example of FIG. 4, the VBC circuitry 402 obtains the R2C angle from the path planning circuitry 302. The VBC circuitry 402 also obtains the signals from the torque sensor 222, and determines an input torque using a Kalman filter approach and a model of the steering system 200, 250 of FIGS. 2A-2B. In other examples, a different type of filter may be used or unfiltered torque may be used. Furthermore, the VBC circuitry 402 obtains a current SWA associated with the steering wheel 206 from the SWA sensor 224. The example VBC circuitry 402 determines a VBC angle request based on the input torque, the SWA, and the R2C angle determined by the path planning circuitry 302. The VBC angle request represents a desired driver steering angle, which is based on the current SWA and driver torque applied to the steering wheel 206. In some examples, the VBC angle request is also based at least partially on vehicle speed, which may be measured by the speed sensor 312 of the vehicle 100. The VBC angle request includes a combination (e.g., summation) of an incremental angle and the current SWA. In some examples, the VBC circuitry 402 is instantiated by programmable circuitry executing VBC instructions and/or configured to perform operations such as those represented by the flowchart(s) of FIGS. 9 and/or 10.

When the vehicle 100 is in the assisted driving mode, the example PF circuitry 316 (FIG. 3) of the path planning circuitry 302 determines a PF angle request, which is used to adjust the steering angle of the vehicle 100 to steer or direct the vehicle 100 along the target path. In FIG. 4, the path planning circuitry 302 is shown as separate from the steering controller 204. For example, the path planning circuitry 302 may be implemented by another controller of the ECU 202. However, in other examples, the path planning circuitry 302 may be part of the steering controller 204. When the driver of the vehicle 100 does not interact with the steering wheel 206 (e.g., zero input torque) during the assisted driving mode, the PF circuitry 316 controls the yaw, direction, and/or steering angle of the vehicle 100. For example, when the driver input torque is zero during the assisted driving mode, the final angle request may be comprised of only the PF angle request. In some examples, the PF circuitry 316 determines the PF angle request based on a reference path for the vehicle 100, a velocity of the vehicle 100, a current steering angle of the steering wheel 206 of FIGS. 2A-2B, and/or a projected path of the vehicle 100.

In the illustrated example of FIG. 4, the steering controller 204 includes the angle blending circuitry 406 to determine the final angle request based on a combination of the VBC angle request, the PF angle request, and an angle blending weight. In some examples, the angle blending weight is an internal signal that ranges in value from 0 to 1, where an angle blending weight of 0 corresponds to no driver input or interaction, and an angle blending weight of 1 corresponds to fully engaged driver interaction. Therefore, when the driver is not interacting (e.g., angle blending weight equals 0), angle control of the vehicle 100 is based solely the PF angle request.

To generate the angle blending weight, the angle blending circuitry 406 can pass the driver input torque through a VBC weight lookup table, which provides a VBC weight (e.g., a preliminary weight) of 0 or 1. That is, when the input torque does not satisfy a VBC weight threshold, the preliminary weight is 0, and when the input torque does satisfy the VBC weight threshold, the preliminary weight is 1. Furthermore, the angle blending circuitry 406 multiplies the VBC weight by an output of a velocity based weight lookup table, which corresponds to a velocity based weight. The angle blending circuitry 406 may access the vehicle speed measured by the speed sensor 312. In some examples, the angle blending circuitry 406 inputs the vehicle speed to the velocity based weight lookup table to determine the velocity based weight. As the input vehicle speed increases, the output velocity based weight decreases. In some examples, the value of the angle blending weight and the contribution of VBC angle request is higher at lower speeds and lower at higher speeds. For example, as long as the driver input torque and the VBC weight is sufficiently high (e.g., a value of 1), at lower speeds the velocity based weight is higher, and at higher speeds the velocity based weight is lower. In some examples, the velocity based weight is 0 when the vehicle speed is greater than a threshold (e.g., 30 miles per hour (mph), 45 mph, 60 mph, etc.). In some examples, the angle blending circuitry 406 is instantiated by programmable circuitry executing angle blending instructions and/or configured to perform operations such as those represented by the flowchart(s) of FIG. 9.

In the illustrated example of FIG. 4, the steering controller 204 includes the conversion circuitry 408 to convert the final angle request to a torque request to be used to adjust the steering angle of the vehicle 100. For example, the conversion circuitry 408 can obtain the final angle request from the angle blending circuitry 406 and determine a torque to be applied by the motor 214 or the first steerable wheel motor 252, the second steerable wheel motor 254, and/or the torque feedback motor 260 to the steering system 200, 250 (e.g., to the gear rack 212, the pinion 210, the steering column 208, the first steerable wheel 218, the second steerable wheel 220, etc.) to achieve the steering angle associated with the final angle request. In some examples, the conversion circuitry 408 uses and/or generates a model of the steering system 200, 250 of FIG. 2A-2B to convert the final angle request to the torque request. For example, the conversion circuitry 408 can account for size, geometry, orientation, material, structure, or other features of the steering system 200, 250 to generate and/or implement the model. In some examples, the model used by the conversion circuitry 408 is generated based on the size and power of the motor 214, length and gear teeth spacing of the gear rack 212, diameter of the steering column 208, a size of the steerable wheels 218, 220, the power of the steerable wheel motors 252, 254, the power of the torque feedback motor 260, etc. In some examples, the conversion circuitry 408 is instantiated by programmable circuitry executing conversion instructions and/or configured to perform operations such as those represented by the flowchart(s) of FIG. 9.

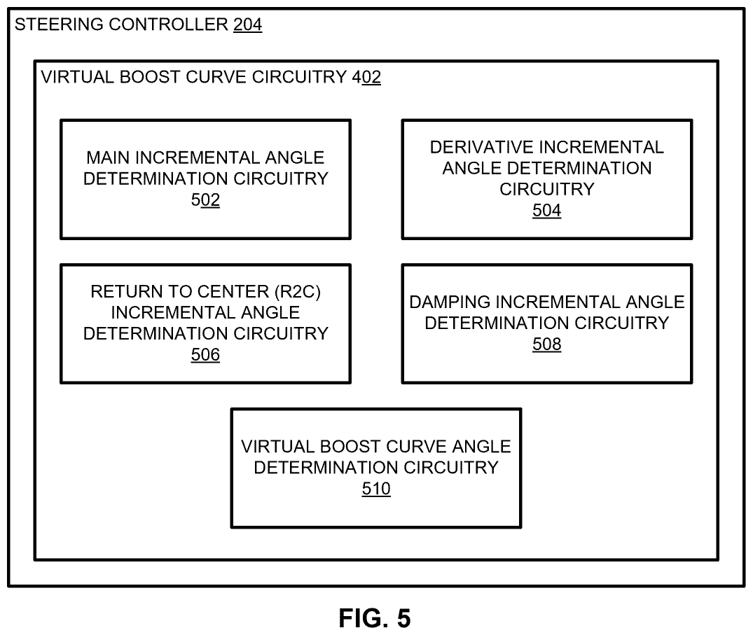

FIG. 5 is a block diagram of an example implementation of the VBC circuitry 402 of FIG. 4 to generate the VBC angle request. The VBC circuitry 402 of FIGS. 4 and 5 may be instantiated (e.g., creating an instance of, bring into being for any length of time, materialize, implement, etc.) by programmable circuitry such as a Central Processor Unit (CPU) executing first instructions. Additionally or alternatively, the VBC circuitry 402 of FIGS. 4 and 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the VBC circuitry 402 includes example main incremental angle determination circuitry 502, example derivative incremental angle determination circuitry 504, example return to center incremental angle determination circuitry 506 (R2C incremental angle determination circuitry 506), example damping incremental angle determination circuitry 508, and example VBC angle determination circuitry 510. In some examples, one or more of the main incremental angle determination circuitry 502, the derivative incremental angle determination circuitry 504, the R2C incremental angle determination circuitry 506, the damping incremental angle determination circuitry 508, and/or VBC angle determination circuitry 510 are combined and/or implemented by the steering controller 204 in circuitry distinct from the VBC circuitry 402. The example VBC circuitry 402 of FIGS. 3 and 4 determines and/or accesses multiple incremental angles (e.g., four incremental angles) and adds these incremental angles to the current SWA to generate the final VBC angle request.

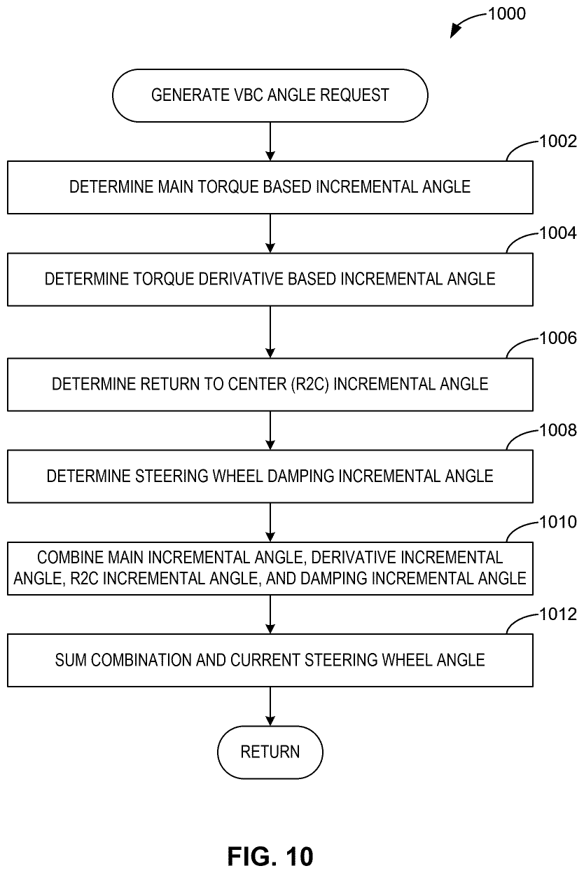

In the illustrated example of FIG. 5, the steering controller 204 includes the main incremental angle determination circuitry 502 to determine a main torque based incremental angle for the VBC angle request. The main incremental angle is used as a base value of the VBC angle request. To determine the main incremental angle, the example main incremental angle determination circuitry 502 passes the input torque through a VBC torque to delta SWA lookup table. For example, the main incremental angle determination circuitry 502 inputs the torque to the lookup table and outputs a delta SWA. In some examples, the main incremental angle determination circuitry 502 implements a virtual wall lookup table to ensure that driver input cannot cause the vehicle 100 of FIG. 1 to move too far off path. Furthermore, in some examples, the main incremental angle determination circuitry 502 implements a velocity based weight lookup table to reduce the value of the main incremental angle as the speed of the vehicle 100 of FIG. 1 increases. In some examples, the main incremental angle determination circuitry 502 is instantiated by programmable circuitry executing main incremental angle determination instructions and/or configured to perform operations such as those represented by the flowchart(s) of FIG. 10.

In the illustrated example of FIG. 5, the steering controller 204 includes the derivative incremental angle determination circuitry 504 to determine a torque derivative based incremental angle for the VBC angle request. In some examples, the VBC angle determination circuitry 510 adds the derivative incremental angle to the main incremental angle to provide some lead action in moving the steering wheel 206. In other words, the derivative incremental angle determination circuitry 504 determines the derivative incremental angle to increase a response time of the steering controller 204. Thus, the derivative incremental angle determination circuitry 504 causes the VBC angle request to have greater influence on angle control of the vehicle 100 over the PF angle request. Furthermore, the derivative incremental angle determination circuitry 404 limits the gain of the main incremental angle to increase responsiveness and maintain stability of the steering system 200, 250 of FIGS. 2A-2B. In some examples, the derivative incremental angle determination circuitry 504 is instantiated by programmable circuitry executing derivative incremental angle determination instructions and/or configured to perform operations such as those represented by the flowchart of FIG. 10.

In the illustrated example of FIG. 5, the steering controller 204 includes the R2C incremental angle determination circuitry 506 to determine a R2C incremental angle for the VBC angle request. In some examples, to return the steering wheel 206 (FIGS. 2A-2B) back to a reference position (e.g., automated vehicle path), the R2C incremental angle is subtracted from the main incremental angle and the derivative incremental angle to determine the VBC angle request. The example R2C incremental angle determination circuitry 506 generates the R2C incremental angle based on the difference between the current SWA and a R2C reference. As used herein, the R2C reference is the R2C angle that the path planning circuitry 302 (FIGS. 3-4) determines. In some examples, the R2C incremental angle determination circuitry 506 includes the path planning circuitry 302. That is, the R2C reference is a SWA angle that corresponds to the trajectory plan. Thus, the steering wheel 206 is urged toward the R2C reference (e.g., the R2C angle output by the path planning circuitry 302) when the vehicle 100 is operating in the assisted driving mode. For example, when the driver applies the input torque to the steering wheel 206, the driver feels the resistance that the R2C incremental angle determination circuitry 506 and/or the path planning circuitry 302 impose on the steering wheel 206 based on the R2C incremental angle and/or the position of the R2C reference. When driving without automated steering based on angle control, the mechanical components of the steering system 200 (e.g., steerable wheels 218, 220, tires, suspension, etc.) or the torque feedback motor 260 (FIG. 2B) cause the steering wheel 206 to naturally return to a central position. However, because the VBC circuitry 402 is continuously controlling the motor 214 (FIG. 2A) or the first steerable wheel motor 252, the second steerable wheel motor 254, and/or the torque feedback motor 260 (FIG. 2B) to steer the vehicle 100, the steering system 200, 250 may not naturally return the vehicle 100 to center while in the assisted driving mode. Thus, the path planning circuitry 302 and the R2C incremental angle determination circuitry 506 are implemented in the steering controller 204 to return to the steering wheel 206 and the steerable wheels 218, 220 to a position that that guides the vehicle 100 along the determined trajectory plan, including a center/neutral position when the trajectory plan includes zero curvature.

In examples disclosed herein, the R2C reference is used in place of a central position (e.g., zero SWA) of the steering wheel 206 (FIGS. 2A-2B). The VBC angle determination circuitry 510 subtracts the R2C incremental angle from the main incremental angle to determine the final VBC angle request. Thus, the path planning circuitry 302 (FIGS. 3-4) determines the R2C reference and the R2C incremental angle determination circuitry 506 determines the R2C incremental angle to provide resistance and/or counteraction to the driver input torque. For example, when the driver input torque is removed from the steering wheel 206 (FIGS. 2A-2B), the R2C incremental angle still has a non-zero value and causes the motor 214 (FIG. 2A) or the first steerable wheel motor 252, the second steerable wheel motor 254, and/or the torque feedback motor 260 (FIG. 2B) to steer the vehicle 100 (FIG. 1) back on the target path. In some examples, the R2C incremental angle determination circuitry 506 is instantiated by programmable circuitry executing R2C incremental angle determination instructions and/or configured to perform operations such as those represented by the flowchart of FIG. 10.

In the illustrated example of FIG. 5, the steering controller 204 includes the damping incremental angle determination circuitry 508 to determine a damping incremental angle for the VBC angle request. The damping incremental angle determination circuitry 508 determines the damping incremental angle to provide a natural steering feel to the VBC angle request. As mentioned above in connection with the R2C incremental angle determination circuitry 506, the mechanical components of the steering system 200, 250 (FIGS. 2A-2B) may not provide feedback (e.g., centering movement) to the driver during self-driving mode. Furthermore, the steering system 200, 250 may not mechanically dampen the steering movement to limit uncontrolled movement and/or oscillation of the steering wheel 206. Thus, the damping incremental angle determination circuitry 508 generates the damping incremental angle to provide negative feedback of the steering wheel velocity (e.g., rate of change of SWA). In other words, while the main incremental angle and the derivative incremental angle cause the steering wheel 206 (FIGS. 2A-2B) to turn (e.g., based on input torque), the R2C incremental angle and the damping incremental angle cause the steering wheel 206 to “spring” back toward an angle associated with the trajectory plan (e.g., PF control).

In some examples, the magnitude of the damping incremental angle is based on vehicle speed such that the higher vehicle speeds result in lower damping incremental angles. Furthermore, in some examples, the magnitude of the damping incremental angle is based on the direction of the SWA. For example, the damping incremental angle is lower when the steering wheel 206 is turned away from center at a certain rate relative to the damping incremental angle when the steering wheel 206 turned toward center at the same rate. In some examples, the damping incremental angle determination circuitry 508 is instantiated by programmable circuitry executing damping incremental angle determination instructions and/or configured to perform operations such as those represented by the flowchart of FIG. 10.

In the illustrated example of FIG. 5, the steering controller 204 includes the VBC angle determination circuitry 510 to determine a final VBC angle request. In some examples, the final VBC angle request is determined based on a combination of the four incremental angles, including (1) the main incremental angle, (2) the derivative incremental angle, (3) the R2C incremental angle, and (4) the damping incremental angle, and the current SWA (or instantaneous SWA). In some examples, the VBC angle determination circuitry 510 obtains the incremental angles (e.g., main, derivative, R2C, damping) from the corresponding circuitry and obtains the current SWA from the SWA sensor 224 (FIGS. 2A-2B). In some examples, to determine the combination of the incremental angles, the example VBC angle determination circuitry 510 sums the main incremental angle and the derivative incremental angle and subtracts the R2C incremental angle and the damping incremental angle. Then, the combination of incremental angles is added to the current SWA to generate the final VBC angle request.

In some examples, in response to the determination of the final VBC angle request, the VBC angle determination circuitry 510 provides the final VBC angle request to the angle blending circuitry 406 to be combined with the PF angle request and generate the final angle request. Additionally or alternatively, the VBC angle determination circuitry 510 provides the final VBC angle request to the motor 214 (FIG. 2A) or the first steerable wheel motor 252, the second steerable wheel motor 254, the torque feedback motor 260 (FIG. 2B), and/or another component of the steering system 200, 250 after the determination of the final VBC angle request. In some examples, the VBC angle determination circuitry 510 is instantiated by programmable circuitry executing final VBC angle determination instructions and/or configured to perform operations such as those represented by the flowchart of FIG. 10.

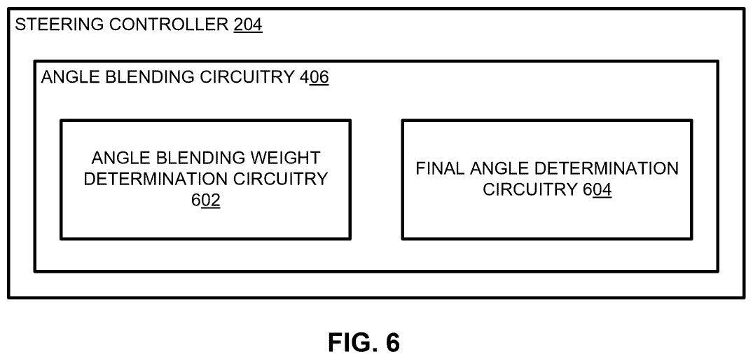

FIG. 6 is a block diagram of an example implementation of the angle blending circuitry 406 of FIG. 4 to generate the angle blending weight and to determine the final angle request to be used to generate the torque response of the motor 214 (FIG. 2A) or the first steerable wheel motor 252, the second steerable wheel motor 254, and/or the torque feedback motor 260 (FIG. 2B). The angle blending circuitry 406 of FIGS. 4 and 6 may be instantiated (e.g., creating an instance of, bring into being for any length of time, materialize, implement, etc.) by programmable circuitry such as a Central Processor Unit (CPU) executing first instructions. Additionally or alternatively, the angle blending circuitry 406 of FIGS. 4 and 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

In the illustrated example of FIG. 6, the angle blending circuitry 406 includes example angle blending weight determination circuitry 602 and example final angle determination circuitry 604. In some examples, one or more of the angle blending weight determination circuitry 602 and/or the final angle determination circuitry 604 are combined and/or implemented by the steering controller 204 in circuitry distinct from the angle blending circuitry 406. The example angle blending circuitry 406 of FIGS. 4 and 6 determines the angle blending weight based on the driver input torque and the vehicle 100. The example angle blending circuitry 406 applies the angle blending weight to the PF angle request and the VBC angle request to determine the final angle request. Thus, the angle blending circuitry 406 can adjust the influence of the VBC circuitry 402 and the PF circuitry 316 on the automatic angle control during the self-driving mode. For example, the angle blending circuitry 406 can increase the VBC angle request and decrease the PF angle request in the final angle request when the vehicle 100 is at lower speeds and vice versa when the vehicle 100 is at higher speeds.

The final angle request sent to the angle controller 410 (e.g., the conversion circuitry 408 and/or the motor 214 (FIG. 2A) or the first steerable wheel motor 252, the second steerable wheel motor 254, and/or the torque feedback motor 260 (FIG. 2B) of FIG. 3) is a combination of and/or based on the VBC angle request and the PF angle request. In some examples, if the driver is not interacting with the steering wheel 206, the final angle request solely comprises the PF angle request. In some examples, the angle blending weight represents an amount of driver interaction with the steering wheel 206 and ranges from 0 to 1, where 1 corresponds to fully engaged driver interaction. In some examples, the angle blending weight determination circuitry 602 is instantiated by programmable circuitry executing angle blending weight determination instructions and/or configured to perform operations such as those represented by the flowchart(s) of FIG. 10. In some examples, the final angle determination circuitry 604 is instantiated by programmable circuitry executing final angle determination instructions and/or configured to perform operations such as those represented by the flowchart of FIG. 10.

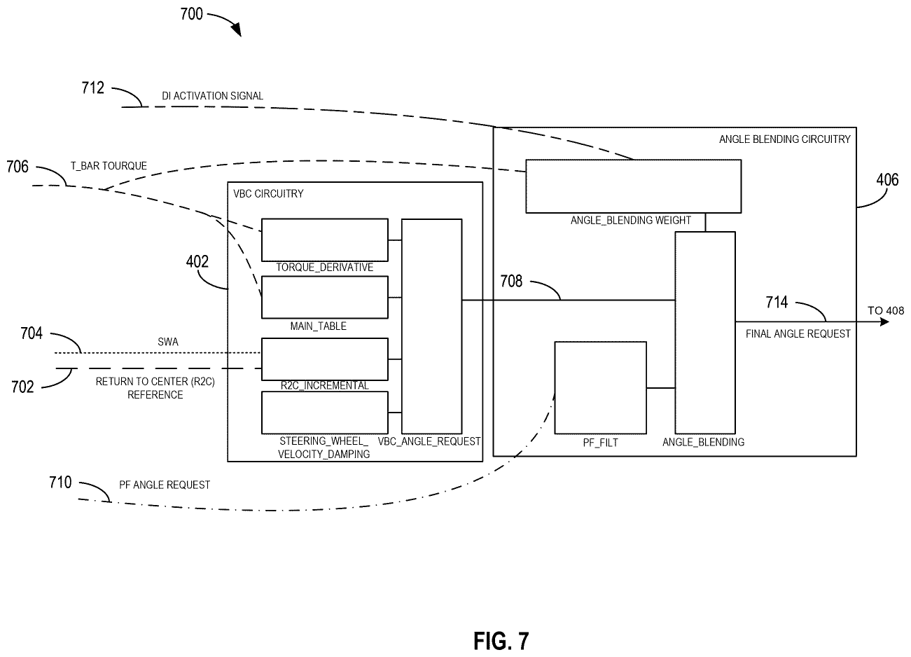

FIG. 7 illustrates an example final angle generation operation 700 that the example steering controller 204 of FIGS. 2-6 performs and/or executes to determine an example final angle request 714. As mentioned, the final angle request 714 is converted to a torque request for the motor 214 (FIG. 2A) or the first steerable wheel motor 252, the second steerable wheel motor 254, and/or the torque feedback motor 260 (FIG. 2B) to apply to the steering system 200, 250 (e.g., the steering wheel 206, the gear rack 212, the pinion 210, the steering column 208, the steerable wheels 218, 220, etc.) of the vehicle 100 to achieve the final steering angle.

In the illustrated example of FIG. 7, the R2C reference 702 determined by the path planning circuitry 302 (FIG. 3), the actual SWA 704 measured by the SWA sensor 224, and a t-bar torque 706 from the torque sensor 222 are communicated to the VBC circuitry 402. In turn, the VBC circuitry 402 determines the four incremental angles, including (1) the main incremental angle, (2) the derivative incremental angle, (3) the R2C incremental angle, and (4) the damping incremental angle, that are then used to determine the VBC angle request 708. The VBC circuitry 402 provides the VBC angle request to the angle blending circuitry 406. The angle blending circuitry 406 also accesses the t-bar torque 706, a PF angle request 710 determined by the PF circuitry 316 (FIG. 3), and a driver interaction activation signal 712 (DI activation signal 712). The angle blending circuitry 406 determines a final angle request 714 and transmits the final angle request to the conversion circuitry 408. When the driver is performing an evasive maneuver, the consideration of the PF angle request in the R2C reference 702 helps guide the vehicle 100 back towards the target path despite the t-bar torque 706 and the DI activation signal 712 producing an angle blending weight that causes the PF angle request 710 to have a reduced effect on the final angle request 714.

While an example manner of implementing the ECU 202 of FIGS. 2A-2B is illustrated in FIGS. 3-6, one or more of the elements, processes, and/or devices illustrated in FIGS. 3-6 may be combined, divided, re-arranged, omitted, eliminated, and/or implemented in any other way. Further, the example steering controller 204, the example path planning circuitry 302, the example maneuver identification circuitry 304, the example trajectory source identification circuitry 306, the example trajectory generation circuitry 308, the example R2C angle calculation circuitry 310, the example PF circuitry 316, the example reference path circuitry 318, the example VBC circuitry 402, the example angle blending circuitry 406, the example conversion circuitry 408, the example main incremental angle determination circuitry 502, the example derivative incremental angle determination circuitry 504, the example R2C incremental angle determination circuitry 506, the example damping incremental angle determination circuitry 508, the VBC angle determination circuitry 510, the example angle blending weight determination circuitry 602, the example final angle determination circuitry 604, and/or, more generally, the example ECU 202 of FIGS. 2A-2B, may be implemented by hardware alone or by hardware in combination with software and/or firmware. Thus, for example, any of the example steering controller 204, the example path planning circuitry 302, the example maneuver identification circuitry 304, the example trajectory source identification circuitry 306, the example trajectory generation circuitry 308, the example R2C angle calculation circuitry 310, the example PF circuitry 316, the example reference path circuitry 318, the example VBC circuitry 402, the example angle blending circuitry 406, the example conversion circuitry 408, the example main incremental angle determination circuitry 502, the example derivative incremental angle determination circuitry 504, the example R2C incremental angle determination circuitry 506, the example damping incremental angle determination circuitry 508, the VBC angle determination circuitry 510, the example angle blending weight determination circuitry 602, the example final angle determination circuitry 604, and/or, more generally, the example ECU 202 of FIGS. 2A-2B, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example steering controller 204 of FIGS. 2A-2B may include one or more elements, processes, and/or devices in addition to, or instead of, those illustrated in FIGS. 3-6, and/or may include more than one of any or all of the illustrated elements, processes and devices.

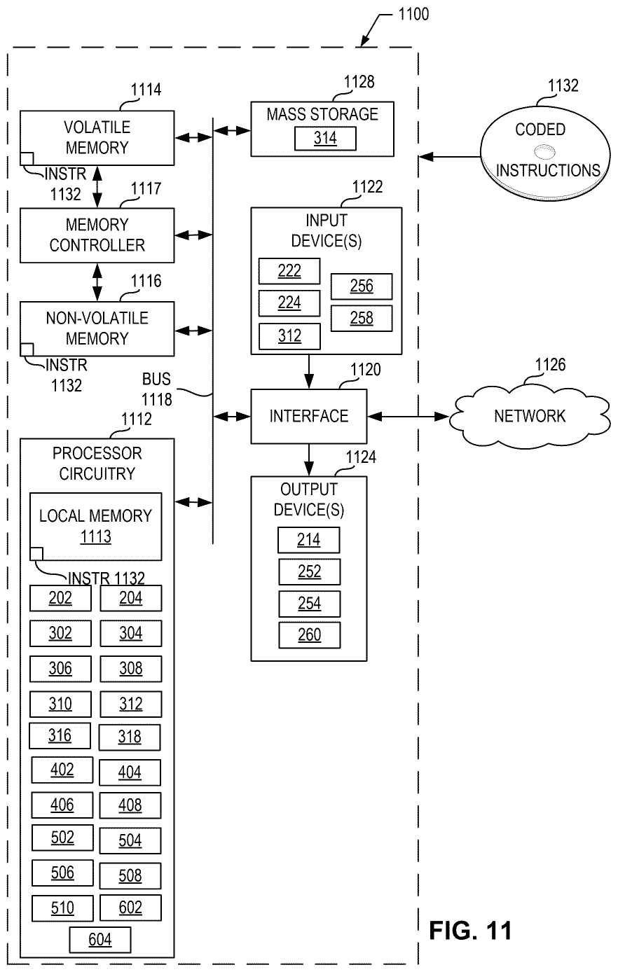

Flowcharts representative of example machine readable instructions, which may be executed by programmable circuitry to implement and/or instantiate the ECU 202 of FIGS. 2A-2B and/or representative of example operations which may be performed by programmable circuitry to implement and/or instantiate the ECU 202 of FIGS. 2A-2B, are shown in FIGS. 8, 9, and 10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by other example programmable circuitry, such as an FPGA. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-10, many other methods of implementing the example steering controller 204 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8, 9, and/or 10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 900 that may be executed, instantiated, and/or performed by programmable circuitry to determine a R2C angle. The example operation of FIG. 8 assumes the vehicle 100 is in the assisted driving mode. The example machine-readable instructions and/or the example operations 800 of FIG. 8 begin at block 802, at which the ECU 202 (FIGS. 2A-2B) accesses or obtains the PF angle request, the torque input, the current SWA, the vehicle speed, and vehicle configuration data. For example, the path planning circuitry 302 (FIG. 3) can query the reference path circuitry 318 for an instantaneous reference path to be followed by the vehicle 100. Further, the path planning circuitry 302 can cause the PF circuitry 316 (FIG. 3) to determine an instantaneous PF angle request associated with the instantaneous reference path. In some examples, when the PF circuitry 316 is implemented by another component of the ECU 202 outside of the path planning circuitry 302, the path planning circuitry 302 can query the PF circuitry 316 (FIG. 3) for the instantaneous PF angle request. In some examples, the path planning circuitry 302 accesses an output of the torque sensor 222 (FIGS. 2A-2B) and determines a torque input based on the sensor output. In some examples, the path planning circuitry 302 accesses the current SWA from the SWA sensor 224 (FIGS. 2A-2B). The path planning circuitry 302 can access the vehicle speed from the speed sensor 312 (FIG. 3). The path planning circuitry 302 can access the vehicle configuration data (e.g., wheelbase, understeer gradient, etc.) via the vehicle configuration database 314 (FIG. 3).

At block 804, the ECU 202 determines whether an evasive maneuver is planned. For example, the maneuver identification circuitry 304 can identify an incoming evasive maneuver in response to the reference path having a fast deviation from a current heading of the vehicle 100 (e.g., a sudden movement within a lane or the like). In some examples, the maneuver identification circuitry 304 determines that the driver is performing an evasive maneuver in response to detecting a steering wheel acceleration that satisfies (e.g., is greater than, is greater than or equal to) an acceleration threshold. The maneuver identification circuitry 304 can determine the steering wheel acceleration based on a change in the SWA and/or the torque input. When the steering controller 204 determines that an evasive maneuver is planned, the operations proceed to block 806. Otherwise, when the steering controller 204 determines that an evasive maneuver is not planned, the operations proceed to block 808.

At block 806, the ECU 202 configures the R2C angle to match the PF angle request. For example, when the maneuver identification circuitry 304 determines that the vehicle 100 is performing an evasive maneuver, the R2C angle calculation circuitry 310 configures the R2C angle to be equivalent to the PF angle request determined by the PF circuitry 316.

At block 808, the ECU 202 determines whether a lane change mode is detected. For example, the path planning circuitry 302 and/or the maneuver identification circuitry 304 can determine that the vehicle 100 is to perform a lane change maneuver based on the reference path from the reference path circuitry 318, an activation of a turn signal, and/or an input from another component of the ECU 202. When the path planning circuitry 302 and/or the maneuver identification circuitry 304 determine that the lane change mode is detected, the operations 800 proceed to block 810. Otherwise, when the path planning circuitry 302 and/or the maneuver identification circuitry 304 determine that the lane change mode is not detected (e.g., the lane keep mode is active), the operations 800 proceed to block 812.

At block 810, the ECU 202 calculates a curvature associated with the trajectory plan for the vehicle 100. For example, when the vehicle 100 is to perform a lane change, the path planning circuitry 302 and/or the trajectory generation circuitry 308 (FIG. 3) calculates the trajectory plan for the vehicle 100 based on an instantaneous trajectory of the vehicle 100, an instantaneous position of the vehicle 100, and a lookahead distance (e.g., a predetermined lookahead distance). In some examples, the trajectory generation circuitry 308 calculates the curvature associated with the trajectory plan using Equations 1 and 2.

At block 812, the ECU 202 calculates the curvature based on a reference path to be followed by the vehicle 100 in maintaining the lane currently occupied by the vehicle 100. For example, when the source is map-based, the reference path circuitry 318 and/or the trajectory generation circuitry 308 determine the curvature of the trajectory plan based on a map-based reference path associated with the lane instantaneously occupied by the vehicle 100 and a lookahead distance. When the source is vision-based, the reference path circuitry 318 and/or the trajectory generation circuitry 308 determine the curvature based on polynomial coefficients (e.g., cubic polynomial coefficients, vision path coefficients, etc.) that correspond to the vision-based path from the reference path circuitry 318 at the lookahead distance. For example, the reference path circuitry 318 and/or the trajectory generation circuitry 308 can determine the curvature from the vision-based polynomial coefficients using Equations 3, 4, and 5.

At block 814, the ECU 202 calculates a steering angle based on the calculated curvature. When maneuver identification circuitry 304 determines that the vehicle 100 is performing a lane keep maneuver or a lane change maneuver, the R2C angle calculation circuitry 310 calculates the steering angle based on the determined curvature of the trajectory plan, the wheelbase, the vehicle speed, the understeer gradient, and the steering ratio.

At block 816, the ECU 202 outputs the calculated steering angle as a R2C reference angle. For example, the path planning circuitry 302 can communicate the R2C reference angle to the VBC circuitry 402 (FIG. 4) and/or the angle controller 409 (FIG. 4).

FIG. 9 is a flowchart representative of example machine readable instructions and/or example operations 900 that may be executed, instantiated, and/or performed by programmable circuitry to adjust a steering angle of a vehicle. The example operation of FIG. 9 assumes the vehicle 100 is in the self-driving mode. The example machine-readable instructions and/or the example operations 900 of FIG. 9 begin at blocks 902, 904, at which the steering controller 204 monitors for torque input. For example, the torque sensor 222 measures torque applied to the steering wheel 206 by the driver. At block 902, the VBC circuitry 402 accesses signals from the torque sensor 222 and can determine the torque input (if any) based on the output signals of the torque sensor 222. At block 904, the VBC circuitry 402 determines whether any torque input has been detected. If no torque input is detected, control proceeds back to block 902 and the VBC circuitry 402 continues to monitor for torque input. In some examples, the VBC circuitry 402 performs this check at a particular frequency set by a clock (e.g., at 100 hertz (hz)).

If torque input is detected, at block 906, the steering controller 204 (FIGS. 2A-2B) accesses or obtains the PF angle request, the R2C angle (e.g., the R2C reference) determined in FIG. 8, the torque input, and the current SWA. For example, the angle blending circuitry 406 can query the PF circuitry 316 for an instantaneous PF angle request. The VBC circuitry 402 can access the R2C angle from the path planning circuitry 302 (FIG. 3). The VBC circuitry 402 can access an output of the torque sensor 222 (FIGS. 2A-2B) and determine a torque input based on the sensor output. The VBC circuitry 402 can access the current SWA from the SWA sensor 224.

At block 908, the steering controller 204 generates the VBC angle request. For example, the VBC circuitry 402 determines various incremental angles and combines them with the current SWA to generate the VBC angle request. Further details regarding block 908 are described below in connection with FIG. 10.

At block 910, the steering controller 204 determines an angle blending weight. For example, the angle blending circuitry 406 and/or the angle blending weight determination circuitry 602 computes the angle blending weight based on the driver input torque and the vehicle speed.

At block 912, the steering controller 204 determines a final angle request. For example the angle blending circuitry 406 and/or the final angle determination circuitry 604 blends the VBC angle request, the PF angle request, and the angle blending weight to calculate the final angle request.

At block 914, this steering controller 204 converts the final angle request to a torque request. For example, the conversion circuitry 408 of FIG. 4 calculates the torque that would cause the steering wheel 206 to rotate or turn to the steering angle associated with the final angle request.

At block 916, the steering controller 204 causes the motor 214 (FIG. 2A) or the first steerable wheel motor 252 (FIG. 2B), the second steerable wheel motor 254 (FIG. 2B), and/or the torque feedback motor 260 to apply the torque request on the steering system 200, 250 (e.g., on the rack 212, on the steerable wheels 218, 220, on the steering wheel 206) of the vehicle 100 to achieve the final angle request. For example, the conversion circuitry 408 sends the torque request to the motor 214 with a command to apply the torque request to the gear rack 212, which thereby adjusts the steering angle of the vehicle 100 to the steering angle associated with the final angle request. Alternatively, the conversion circuitry 408 can send the torque request to the first steerable wheel motor 252 and the second steerable wheel motor 254, which thereby adjust the steering angle of the vehicle 100 to the steering angle associated with the final angle request. In some examples, the conversion circuitry 408 sends the torque request to the torque feedback motor 260, which adjusts the SWA and/or a torque provided to the steering wheel 206 based on the steering angle associated with the final angle request.

In some examples, control proceeds back to block 902 and the steering controller 204 continues to monitor for additional torque input, such as when the driver is applying torque to the steering wheel 206. The example process may be repeated continuously while the vehicle 100 is in the assisted driving mode. However, if the self-driving mode is deactivated and/or the vehicle 100 is turned off, the example process and/or operation 900 ends.

FIG. 10 is a flowchart representative of example machine readable instructions and/or example operations 1000 that may be executed, instantiated, and/or performed by programmable circuitry to generate the VBC angle request. The example machine-readable instructions and/or the example operations 1000 of FIG. 10 may correspond to the operation(s) performed at block 908 of FIG. 9. The example machine-readable instructions and/or the example operations 1000 of FIG. 10 begin at block 1002, at which the steering controller 204 (FIGS. 2A-2B) determines a main torque based incremental angle. For example, the VBC circuitry 402 (FIG. 4) and/or the main incremental angle determination circuitry 502 (FIG. 5) determines the main incremental angle based on the operations 1000 of FIG. 10.

At block 1004, the steering controller 204 determines a torque derivative based incremental angle. For example, the VBC circuitry 402 and/or the derivative incremental angle determination circuitry 404 of FIG. 4 determines the derivative incremental angle.

At block 1006, the steering controller 204 determines an R2C incremental angle. For example, the VBC circuitry 402 and/or the R2C incremental angle determination circuitry 506 of FIG. 5 determines the R2C incremental angle based on the R2C reference and the current SWA. The path planning circuitry 302 (FIG. 3) can determine the R2C reference based on the operations 800 of FIG. 8.

At block 1008, the steering controller 204 determines a steering wheel damping incremental angle. For example, the VBC circuitry 402 and/or the damping incremental angle determination circuitry 508 of FIG. 5 determines the damping incremental angle.

At block 1010, the steering controller 204 combines the main incremental angle, the derivative incremental angle, the R2C incremental angle, and the damping incremental angle. For example, the VBC circuitry 402 and/or the VBC angle determination circuitry 510 of FIG. 5 combines the incremental angles.

At block 1012, the steering controller 204 sums the combination of block 1012 with the current SWA. For example, the VBC circuitry 402 (FIG. 4) and/or the VBC angle determination circuitry 510 adds the combination to the current SWA. After block 1014, control returns to block 910 of FIG. 9.

FIG. 11 is a block diagram of an example programmable circuitry platform 1100 structured to execute and/or instantiate the example machine-readable instructions and/or the example operations of FIGS. 8-10 to implement the ECU 202 of FIGS. 2A-2B. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example ECU 202, the example steering controller 204, the example path planning circuitry 302, the example maneuver identification circuitry 304, the example trajectory source identification circuitry 306, the example trajectory generation circuitry 308, the example R2C angle calculation circuitry 310, the example PF circuitry 316, the example reference path circuitry 318, the example VBC circuitry 402, the example angle blending circuitry 406, the example conversion circuitry 408, the example main incremental angle determination circuitry 502, the example derivative incremental angle determination circuitry 504, the example R2C incremental angle determination circuitry 506, the example damping incremental angle determination circuitry 508, the VBC angle determination circuitry 510, the example angle blending weight determination circuitry 602, and/or the example final angle determination circuitry 604.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 may include the torque sensor 222, the SWA sensor 224, the speed sensor 312, the first steerable wheel position sensor 256, and/or the second steerable wheel position sensor 258. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can include the motor 214, the first steerable wheel motor 252, the second steerable wheel motor 254, and/or the torque feedback motor 260. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 8, 9, and/or 10, may be stored in the mass storage device 1128, in the volatile memory 1114, in the non-volatile memory 1116, and/or on at least one non-transitory computer readable storage medium such as a CD or DVD which may be removable.

From the foregoing, it will be appreciated that example systems, apparatus, and methods have been disclosed that determine a R2C angle for an assisted (e.g., autonomous, semi-autonomous, etc.) driving vehicle. The R2C angle determination enables the vehicle to react accordingly to different driving maneuvers that the vehicle may encounter. Additionally, the R2C angle utilization helps reduce a delay in returning to a desired trajectory after performing an evasive maneuver. Further, example systems, apparatus, and methods adjust the steering wheel angle of a vehicle based at least partially on the determined R2C angle. Disclosed systems, apparatus, articles of manufacture, and methods improve the efficiency of using a computing device and a steering system of a vehicle by enabling an angle control interface for an angle based self-driving control system of the vehicle.

Methods and apparatus to configure a return-to-center angle for a steering wheel are disclosed herein. Further examples and combinations thereof include the following:

Example 1 includes a vehicle comprising a steering wheel, a steerable wheel, the steering wheel operatively coupled to the steerable wheel, a steering motor to be activated to control a steering angle of the steering wheel while the vehicle is in an assisted driving mode, and a steering controller including instructions and programmable circuitry to execute the instructions to access a trajectory plan for the vehicle, the trajectory plan including a curvature, determine a return-to-center (R2C) angle for the steering wheel based on the trajectory plan and a vehicle speed, the R2C angle being non-zero, and cause the steering motor to bias the steering angle of the steering wheel towards the R2C angle in response to the steering wheel receiving a torque input from a driver.

Example 2 includes the vehicle of example 1, wherein the steering motor provides a counteraction torque resistance that acts in an opposite direction from the torque input relative to the R2C angle to bias the steering angle towards the R2C angle.

Example 3 includes the vehicle of any preceding example, wherein the programmable circuitry is to convert the curvature to the R2C angle based on a wheelbase parameter, a steering ratio parameter, an understeer gradient, the vehicle speed, and the curvature.

Example 4 includes the vehicle of any preceding example, wherein the programmable circuitry is to determine whether an evasive maneuver is to occur, and when the evasive maneuver is to occur, cause the R2C angle to correspond to a path follower (PF) angle request, the PF angle request including the curvature.

Example 5 includes the vehicle of any preceding example, wherein the programmable circuitry is to determine whether the trajectory plan includes a lane change for the vehicle, when the trajectory plan includes the lane change calculate the curvature for the trajectory plan based on a current trajectory of the vehicle and a lookahead point on the current trajectory, and determine the R2C angle based on the curvature.

Example 6 includes the vehicle of any preceding example, wherein the programmable circuitry is to calculate the curvature based on a pure pursuit law.

Example 7 includes the vehicle of any preceding example, wherein, when the trajectory plan includes maintaining a current lane for the vehicle, the instructions are to cause programmable circuitry to calculate the R2C angle based on a reference path, a wheelbase, a vehicle speed, an understeer gradient, and a steering ratio.

Example 8 includes a non-transitory machine readable storage medium comprising instructions to cause programmable circuitry to at least identify a trajectory plan for a vehicle, determine a return-to-center (R2C) angle for a steering wheel based on the trajectory plan, the R2C angle being non-zero, and cause a steering motor to bias a steering angle of the steering wheel towards the R2C angle in response to the steering wheel receiving a torque input from a driver.

Example 9 includes the non-transitory machine readable storage medium of any preceding example, wherein, to identify the trajectory plan for the vehicle, the instructions are to cause programmable circuitry to determine whether an evasive maneuver is to occur, and when the evasive maneuver is to occur, cause the R2C angle to correspond to a path follower (PF) angle request, the PF angle request including a curvature.

Example 10 includes the non-transitory machine readable storage medium of any preceding example, wherein the instructions are to cause programmable circuitry to determine whether the trajectory plan includes a lane change for the vehicle, when the trajectory plan includes the lane change calculate a curvature for the trajectory plan based on a current trajectory of the vehicle and a lookahead point, and determine the R2C angle based on the curvature.

Example 11 includes the non-transitory machine readable storage medium of any preceding example, wherein the instructions are to cause programmable circuitry to calculate the curvature based on a pure pursuit law.

Example 12 includes the non-transitory machine readable storage medium of any preceding example, wherein, when the trajectory plan includes maintaining a current lane for the vehicle, the instructions are to cause programmable circuitry to calculate the R2C angle based on a reference path, a wheelbase, a vehicle speed, an understeer gradient, and a steering ratio.

Example 13 includes the non-transitory machine readable storage medium of any preceding example, wherein the trajectory plan for the vehicle includes a curvature, wherein the instructions are to cause programmable circuitry to determine the curvature based on a map-based reference path at a lookahead distance, and convert the curvature to a steering angle to determine the R2C angle.

Example 14 includes the non-transitory machine readable storage medium of any preceding example, wherein the trajectory plan for the vehicle includes a curvature, wherein the instructions are to cause programmable circuitry to determine polynomial coefficients based on a vision-based reference path and a lookahead distance determine the curvature based on the polynomial coefficients, and convert the curvature to a steering angle to determine the R2C angle.

Example 15 includes a method comprising identifying a trajectory plan for a vehicle, determining a return-to-center (R2C) angle based on the trajectory plan, and causing a steering motor to bias a steering angle towards the R2C angle in response to a steering wheel receiving a torque input from a driver.

Example 16 includes the method of any preceding example, wherein identifying the trajectory plan for the vehicle includes determining whether an evasive maneuver is to occur, and when the evasive maneuver is to occur, causing the R2C angle to correspond to a path follower (PF) angle request, the PF angle request including a curvature.

Example 17 includes the method of any preceding example, further including determining whether the trajectory plan includes a lane change for the vehicle, when the trajectory plan includes the lane change calculating a curvature for the trajectory plan based on a current trajectory of the vehicle and a lookahead point on the current trajectory, and determining the R2C angle based on the curvature.

Example 18 includes the method of any preceding example, further including determining the trajectory plan includes maintaining a current lane occupied by the vehicle, and calculating the R2C angle based on a reference path, a wheelbase, a vehicle speed, an understeer gradient, and a steering ratio.

Example 19 includes the method of any preceding example, wherein the trajectory plan for the vehicle includes a curvature, and further including determining the curvature based on a map-based reference path at a lookahead distance, and converting the curvature to a steering angle to determine the R2C angle.

Example 20 includes the method of any preceding example, wherein the trajectory plan for the vehicle includes a curvature, and further including determining polynomial coefficients based on a vision-based reference path and a lookahead distance determining the curvature based on the polynomial coefficients, and converting the curvature to a steering angle to determine the R2C angle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a steering wheel;
a steerable wheel, the steering wheel operatively coupled to the steerable wheel;
a steering motor to be activated to control a steering angle of the steering wheel while the vehicle is in an assisted driving mode; and
a steering controller including instructions and programmable circuitry to execute the instructions to:
access a trajectory plan for the vehicle, the trajectory plan including a curvature;
determine a return-to-center (R2C) angle for the steering wheel based on the trajectory plan and a vehicle speed; and
cause the steering motor to bias the steering angle of the steering wheel towards the R2C angle in response to the steering wheel receiving a torque input from a driver.

2. The vehicle of claim 1, wherein the steering motor provides a counteraction torque resistance that acts in an opposite direction from the torque input relative to the R2C angle to bias the steering angle towards the R2C angle.

3. The vehicle of claim 1, wherein the programmable circuitry is to convert the curvature to the R2C angle based on a wheelbase parameter, a steering ratio parameter, an understeer gradient, the vehicle speed, and the curvature.

4. The vehicle of claim 1, wherein the programmable circuitry is to:
determine whether an evasive maneuver is to occur; and
when the evasive maneuver is to occur, cause the R2C angle to correspond to a path follower (PF) angle request, the PF angle request including the curvature.

5. The vehicle of claim 1, wherein the programmable circuitry is to:
determine whether the trajectory plan includes a lane change for the vehicle;
when the trajectory plan includes the lane change:
calculate the curvature for the trajectory plan based on a current trajectory of the vehicle and a lookahead point on the current trajectory; and
determine the R2C angle based on the curvature.

6. The vehicle of claim 5, wherein the programmable circuitry is to calculate the curvature based on a pure pursuit law.

7. The vehicle of claim 5, wherein, when the trajectory plan includes maintaining a current lane for the vehicle, the instructions are to cause programmable circuitry to calculate the R2C angle based on a reference path, a wheelbase, a vehicle speed, an understeer gradient, and a steering ratio, the reference path including the curvature.

8. A non-transitory machine readable storage medium comprising instructions to cause programmable circuitry to at least:
identify a trajectory plan for a vehicle;
determine a return-to-center (R2C) angle for a steering wheel based on the trajectory plan, the R2C angle being non-zero; and
cause a steering motor to bias a steering angle of the steering wheel towards the R2C angle in response to the steering wheel receiving a torque input from a driver.

9. The non-transitory machine readable storage medium of claim 8, wherein, to identify the trajectory plan for the vehicle, the instructions are to cause programmable circuitry to:
determine whether an evasive maneuver is to occur; and
when the evasive maneuver is to occur, cause the R2C angle to correspond to a path follower (PF) angle request, the PF angle request including a curvature.

10. The non-transitory machine readable storage medium of claim 8, wherein the instructions are to cause programmable circuitry to:
determine whether the trajectory plan includes a lane change for the vehicle;
when the trajectory plan includes the lane change:
calculate a curvature for the trajectory plan based on a current trajectory of the vehicle and a lookahead point; and
determine the R2C angle based on the curvature.

11. The non-transitory machine readable storage medium of claim 10, wherein the instructions are to cause programmable circuitry to calculate the curvature based on a pure pursuit law.

12. The non-transitory machine readable storage medium of claim 10, wherein, when the trajectory plan includes maintaining a current lane for the vehicle, the instructions are to cause programmable circuitry to calculate the R2C angle based on a reference path, a wheelbase, a vehicle speed, an understeer gradient, and a steering ratio.

13. The non-transitory machine readable storage medium of claim 8, wherein the trajectory plan for the vehicle includes a curvature, wherein the instructions are to cause programmable circuitry to:
determine the curvature based on a map-based reference path at a lookahead distance; and
convert the curvature to a steering angle to determine the R2C angle.

14. The non-transitory machine readable storage medium of claim 8, wherein the trajectory plan for the vehicle includes a curvature, wherein the instructions are to cause programmable circuitry to:
determine polynomial coefficients based on a vision-based reference path and a lookahead distance
determine the curvature based on the polynomial coefficients; and
convert the curvature to a steering angle to determine the R2C angle.

15. A method comprising:
identifying a trajectory plan for a vehicle;
determining a return-to-center (R2C) angle based on the trajectory plan; and
causing a steering motor to bias a steering angle towards the R2C angle in response to a steering wheel receiving a torque input from a driver.

16. The method of claim 15, wherein identifying the trajectory plan for the vehicle includes:
determining whether an evasive maneuver is to occur; and
when the evasive maneuver is to occur, causing the R2C angle to correspond to a path follower (PF) angle request, the PF angle request including a curvature.

17. The method of claim 15, further including:
determining whether the trajectory plan includes a lane change for the vehicle;
when the trajectory plan includes the lane change:
calculating a curvature for the trajectory plan based on a current trajectory of the vehicle and a lookahead point on the current trajectory; and
determining the R2C angle based on the curvature.

18. The method of claim 15, further including:
determining the trajectory plan includes maintaining a current lane occupied by the vehicle; and
calculating the R2C angle based on a reference path, a wheelbase, a vehicle speed, an understeer gradient, and a steering ratio.

19. The method of claim 15, wherein the trajectory plan for the vehicle includes a curvature, and further including:
determining the curvature based on a map-based reference path at a lookahead distance; and
converting the curvature to a steering angle to determine the R2C angle.

20. The method of claim 15, wherein the trajectory plan for the vehicle includes a curvature, and further including:
determining polynomial coefficients based on a vision-based reference path and a lookahead distance
determining the curvature based on the polynomial coefficients; and
converting the curvature to a steering angle to determine the R2C angle.
